(19) United States
(12) Patent Application Publication
(10) Pub. No.: US 2004/0186713 A1
(43) Pub. Date: Sep. 23, 2004

(54) Content delivery and speech system and apparatus for the blind and print-handicapped

(76) Inventors: Steven W. Gomas, Danville, CA (US); Edward H. Theil, Oakland, CA (US)

Correspondence Address: Pepper Hamilton LLP, 50th Floor, One Mellon Center, 500 Grant Street, Pittsburgh, PA, 15219, US

(21) Appl. No.: 10/681,537

(22) Filed: Oct. 8, 2003

Related U.S. Application Data
(60) Provisional application No. 60/452,455, filed on Mar. 6, 2003.

(51) Int. Cl. G10L 15/00; G10L 15/26

(52) U.S. Cl. 704/235

(57) ABSTRACT

A portable electronic device includes a user interface that is adapted to be operated by a print-disabled individual, a memory storing a database of content, a text-to-speech converter, and an audio output. The device may include time scale modification, decompression and decryption functions. The device's content database includes index files, one or more libraries, tables of contents and/or catalog files. The device may be part of a system that receives content updates from a remote server content database. The devices may periodically communicate with the server to receive updates that the server receives from one or more remote sources. The system may also include an audio file generator that pre-processes the content files.

### RELATED APPLICATIONS AND CLAIM OF PRIORITY

This application claims priority to the co-pending U.S. provisional patent application No. 60/452,455, filed Mar. 6, 2003, entitled “Content Delivery and Speech System and Apparatus for the Blind and Print-Handicapped,” which is incorporated herein by reference in its entirety.

### FIELD OF THE INVENTION

The present invention generally relates to methods and systems for communicating media content to disabled or impaired individuals. More specifically, the invention relates to methods and systems, including text-to-speech conversion devices, for delivering text to persons having handicaps that prevent them from enjoying normal literacy, such as blindness, visual impairment, dyslexia, macular degeneration, and illiteracy.

### BACKGROUND OF THE INVENTION

### DESCRIPTION OF THE RELATED ART

For at least twenty-five years, computer technology that provides spoken versions of visual symbols and text has been available in a variety of constantly improving forms. The focus of this work has, until recently, centered on the computer keyboard and computer screen or monitor. Early versions of keyboard “speakers”, which pronounced the name of each key as it was depressed, were followed by the first text-to-speech programs that, in the 1980's and later, evolved into “screen readers” which enable a person to listen to the content of the material that appears on the computer's monitor. Much of this technology has been driven by the needs of users who are visually impaired, and it has served very useful purposes.

Nevertheless, there are several important weaknesses inherent in the various text-to-speech readers currently available. Two such weaknesses stem from the fact that the design of text-to-speech devices, whether they are software, hardware or a combination of both, are computer-centric; that is,

They require that the user interact with and be in close proximity to a traditional computer in order to hear what is on the screen and to navigate through a text.

They implicitly require that the user have ready access to a computer and be at least reasonably computer-literate. Unfortunately, the majority of people who are visually impaired do not fall into that category, because of lack of appropriate training, or age, or both.

More recently, as computer processors and memory have increased in power and capacity and diminished in physical size, a number of hand-held devices have appeared for use by the general population. Some of these devices feature artificial speech, but, in almost all cases, they are still designed for the average sighted user and continue to suffer from the same two limitations described above. Complaints about these devices frequently relate to the size of the screen and the complexity of the interface. For persons having handicaps that prevent them from enjoying normal literacy, such as blindness, visual impairment, dyslexia, macular degeneration and illiteracy, referred to herein as “print-handicapped” or “print-disabled” individuals, the first such complaint is inapposite. However, the second complaint may limit their use of such devices because the interface is often too complex for them.

A related problem lies with the distribution of digitized materials to the print-handicapped population. As noted above, many individuals with print handicaps encounter difficulty with modem methods of communication, notably the Internet. In addition, many individuals, including but not limited to print-handicapped individuals, do not have broadband network connections needed for substantial downloads in their home. Thus, the very practical problem of getting digital materials to print-disabled individuals exists.

On the other hand, the advantages in electronic miniaturization have been recognized in prior art in this field as targeted toward the great majority of users who are sighted. However, that art does not address the needs of those who are, for one reason or another, print-handicapped. For example, icons on a page-like touch screen, or other visual aids and prompts, are not appropriate for this audience, or for others who are not able to visually focus on the device.

The present invention and method addresses this situation by providing both an apparatus and collection of methods that are designed with these problems specifically in mind. The device and methods, taken as a system, are designed to be easy to use, even for those who are non-sighted or reading-disabled, and to provide a portable means of handling a wide variety of printed media in a uniform way.

### SUMMARY OF THE INVENTION

One embodiment of the invention includes an electronic distribution system in which a Server computer communicates with any number of remote, portable electronic listening units called Clients in this embodiment. By any of several methods, the Server prepares and distributes Content obtained by interfacing automatically (in a data-driven manner) with any number of Content Providers. The latter are either publishers or middle-man distributors of conventional published material. The Server may be embodied in a conventional computer running software processes that create a “Virtual Newsstand,” accessible via a communications network such as the Internet.

Clients, by contrast, are special purpose, hand-held, portable electronic devices with embedded computers and software. In preferred embodiments, Clients may have several complementary capabilities. They may do one or all of the following:

navigate through and “speak” electronic text which has been downloaded or otherwise distributed from the Server;

“play” audio files using a high-quality audio format such as MP3. Such audio files are not limited to music but also preferably include higher quality synthetic speech reproduction of newspaper or magazine articles or other printed materials;

be used as hand-held web browsers especially designed for the visually impaired.

In order to provide a high level of functionality and usefulness in the Client, a number of features are preferably supported in the User Interface, including the ability to move easily and quickly from one kind of document to another with audible prompts.

Thus, an embodiment of the invention provides a small, portable device with which persons with reading disabilities, and those with little or no computer experience or training, may:

1. listen to a computer-generated voice “reading” (speaking) any of a large number of periodicals, including magazines and/or newspapers, that are stored in digital form on the Client;

2. listen to books that have specifically been made available in digital form and pre-processed on the Server for text-to-speech;

3. interact with the Client device to navigate through virtual libraries of material without the need for explicit visualization; and/or

4. use the Client for a variety of educational purposes, including literacy and grammar exercises.

An embodiment of the invention also provides a user interface on the portable unit (Client) which is specifically designed for print-handicapped people, and which has features that include “one key” and/or “two key” protocols that facilitate navigation through the material without the need for visual prompts.

An embodiment of the invention also provides a user interface with navigation methods using physical keys combined with software data structures that may teach the visually-disabled how newspapers and magazines are organized, both in the world at large and in the form of digital electronic media.

An embodiment of the invention also provides users with a device that integrates a novel means of listening to high-quality digitally generated synthetic voices and a means to navigate through the documents being read by such voices, together with standard audio quality for other documents produced in a more immediate manner.

An embodiment of the invention also provides a novel electronic distribution system for published materials such as books and periodicals, customized for the print-handicapped (including the blind) and a method whereby this same group can access these materials on a subscription basis in a timely manner.

An embodiment of the invention also provides a catalog of available content, embedded in the Client device, which the user may browse and use to order new materials at any time. Preferably, the catalog is periodically updated with a new version, which may, for example, occur every time the user receives new Content files.

Yet another embodiment of the invention provides a portable electronic device (the “Client”) that is compatible with, and can easily access, an Internet Server or other communications server that functions as a Virtual Newsstand without the need for visual aids or printed text. The Client can be used in stand-alone mode or in interaction with the Server to form an overall system, and it may be used without substantial difficulty by or substantial special training of the print-handicapped population.

An embodiment of the invention also provides a method whereby publishers of different kinds of print media, such as newspapers, magazines and/or books (the Content Providers) can make their publications available to print-handicapped persons by utilizing the method and capabilities of the Server and its associated distribution system at very low cost, including security and privacy features consistent with the digital rights of the publishers.

An embodiment of the invention also provides a set of software data structures, along with processes (programs) that operate on them, with which a variety of published material may be categorized and stored on the Client, such that a print-disabled person can navigate among and within the publications without the need for visualization or extensive training.

A summary of an embodiment of the invention is that it provides a portable electronic device that includes a user interface adapted to be operated by a print-disabled individual, a memory that contains a database of content, a text-to-speech converter, and an audio output. Preferably, when the content files are in compressed text format, the device is configured to decompress the text format content files, and the text-to-speech converter is configured to deliver the decompressed text format content files in audio format in response to a user input. The device preferably also includes a communication means that receives content updates from a remote computing device. It may also include a processor programmed with time scale modification functions that adjust a delivery speed of the content when the content is presented to a user through the audio output. When a user selects an audio format file, the text-to-speech converter may be programmed to convert selected non-audio format information associated with the audio format file into an audio format and present the converted selected information to the user as text-to-speech. The device may also include a decompression module that decompresses a user-selected compressed audio content file or text format file in real time during presentation of the file in audio format to the individual. Further, it may include a decryption module that, when a user selects a content file that is encrypted, decrypts the selected content file.

In an alternate embodiment, a content delivery system includes a server having a server content database and a server subscriber database, as well as one or more portable electronic devices. Each portable electronic device is in communication with the server. Each portable electronic device also includes a user interface adapted to be operated by a print-disabled individual, a memory that contains a device content database, a text-to-speech converter and an audio output. Preferably, each portable electronic device is programmed to periodically communicate with the server, receive an update from the server content database, and update the device content database with the update from the server content database. The content database of the portable device includes compressed audio format content files and/or text format content files. The system may also include an audio file generator in communication with the server for pre-processing the compressed audio format content files. The system may also include one or more communications links between the server and a plurality of remote content providers. At least a portion of the content in the server content database is preferably received from remote content providers via link or links. Each portable electronic device preferably also includes a processor programmed with time scale modification functions that adjust a delivery speed of content from the content information database when said content is presented to a user through the audio output.

In accordance with an alternate embodiment, a method of delivering content to a print-disabled or visually-impaired individual includes providing the individual with a portable electronic device, wherein the device includes a user interface, a memory that contains text format content files and audio format content files, a text-to-speech converter for converting the text format content files to audio format, a processor programmed with time scale modification functions, and an audio output. The method also includes periodically updating the memory with updated text format content files and updated audio format content files. Preferably, at least one of the updated text format content files has been received from a remote content provider. The step of periodically updating may be performed by contacting a remote server via a communications link and/or by providing the user with a replacement memory that contains the updated text format content files and audio format content files. Preferably, the method also includes pre-processing the audio format content files. The method may also include the step of providing the electronic device with at least one index file for each text format content file and audio format content file. In response to a request from a user to receive a content file, the method may also include the step of verifying that the user is authorized to receive the requested content file.

In accordance with another embodiment, a database structure includes a plurality of content files. The content files include text format files and audio format files. The database also includes a plurality of index files, wherein at least one index file is associated with one of the content files, and wherein at least one index file includes data corresponding to a plurality of locations within the associated content file. Preferably, each of the content files is associated with at least one library, and each library includes a table of contents. The index files may include data corresponding to a title of the associated content file. The database structure preferably also includes at least one catalog file that includes data corresponding to a plurality of available content files.

There have thus been outlined the more important features of the invention in order that the detailed description that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

### BRIEF DESCRIPTION OF THE DRAWINGS

FIG. 1 is a block diagram of an embodiment of the overall system, showing a Server, an associated audio “farm” of computers that generate synthetic speech, and one of potentially many Clients.

FIG. 2 is a block diagram of a preferred internal architecture of the Server.

FIG. 3 illustrates one embodiment of the exterior of a Client showing the keys that comprise the user interface and a removable memory card.

FIG. 4 is a block diagram of a preferred internal architecture of the Client.

FIG. 5 is a partial view of features of an embodiment of the Content Information Database, in this example showing a database table including four records.

FIG. 6 is a partial view of an embodiment of the Subscriber Database, in this example showing a database table including three records corresponding to two subscribers.

FIG. 7 is an example of the Subscription Database, showing a database table including three records related to the two subscribers represented in FIG. 6.

FIGS. 8, 9 and 10 are flow charts depicting the logical flow of embodiments of operations performed by the Server in order to convert the content files obtained from Content Providers to a form ready for downloading to Clients.

FIG. 11 illustrates embodiments of index tables that are formed as part of the conversion process.

FIG. 12 is a representation of a typical folder and file structure used on the Client. Such structures constitute a “Virtual Library” on the Client.

FIG. 13 is an exemplar of navigation levels within a newspaper as expressed by a Client's folder and file structure.

FIG. 14 is an exemplar of navigation levels within a magazine as expressed by a Client's folder and file structure.

FIG. 15 is an exemplar of navigation levels within a book as expressed by a Client's folder and file structure.

FIG. 16 is an exemplar of navigation levels within the Client's Catalog, as described in Section III of the Detailed Description.

FIG. 17 is a flow chart that depicts an embodiment of the logical flow of operations performed by the Server during the course of downloading files to the Client.

FIG. 18 is a table that represents an embodiment of the Client's key configuration, with the preferred primary and secondary functions of each key named beneath the number.

FIGS. 19-39 contain flow charts depicting embodiments of the logical flow of operations performed by the Client's responses to user commands. See Section IV of the Detailed Description.

### DETAILED DESCRIPTION OF PREFERRED EMBODIMENTS

Nomenclature and Assumptions

In the following, the term “Content” refers to any of several different types of electronic media, including but not limited to digitized versions of newspapers, magazines and books. The terms “user,” “subscriber” and “listener” are used interchangeably. The words “speak” and “announce” are also used interchangeably. In addition, the verb “read” and the verb “speak” are sometimes used interchangeably herein to emphasize that materials normally read are spoken in this invention. The terms “device” and “Client” are used interchangeably, as are the terms “document” and “content file.”

One skilled in the art will understand that the Server system can refer as well to a plurality of such Servers, and that some Server tasks to be described below may be allocated and executed on several computers, rather than one.

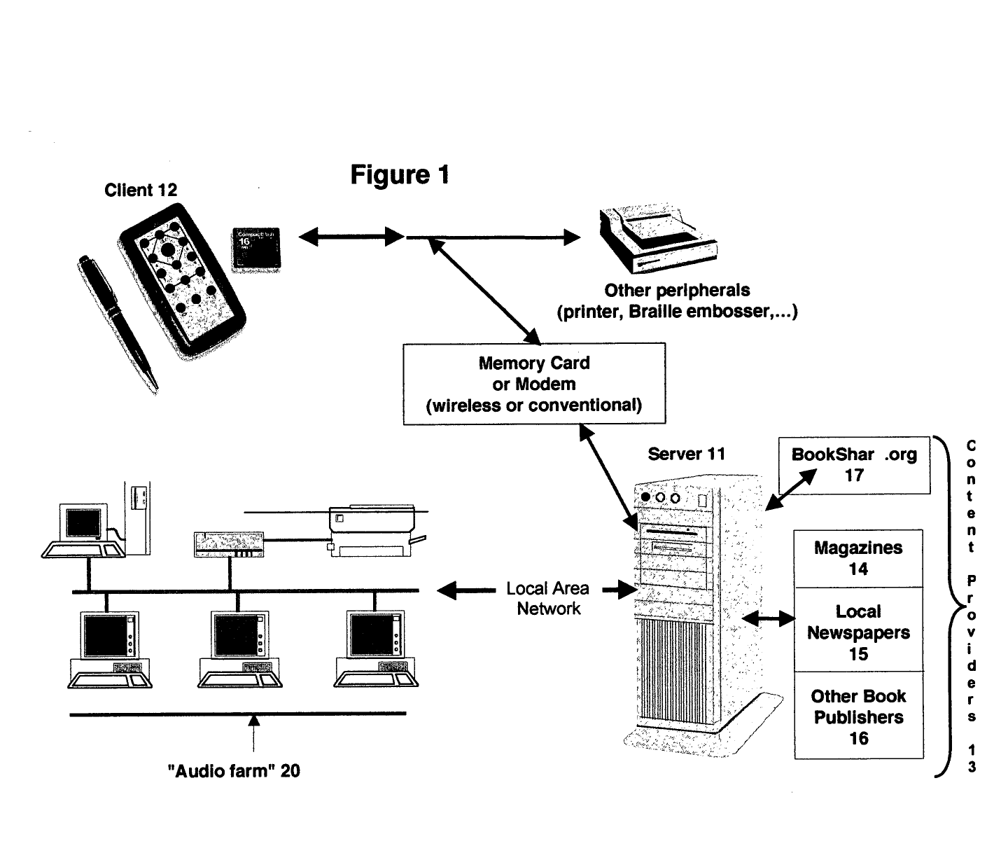

The preferred system includes, as shown in FIG. 1, four principal components: a Server 11, an “audio farm” 20 (which may or may not be integral with the Server), the Clients 12, and the Content Providers 13. The Server 11 must interact with the other components, while the Client 12 need only interact directly or indirectly with the Server 11. Accordingly, the detailed description is divided into four parts:

I. a description of an embodiment of the overall system in terms of its components;

II. a description of the Server-Content Provider processes, which move content to the Server 11 where it is pre-processed for speech and navigation on the Client 12;

III. a description of the Client-Server processes, which move the processed content to the Client 12; and

IV. a description of the use of the Client 12 to listen to a variety of media as a stand-alone device that has been loaded with digital content.

### I. Description of the Overall System

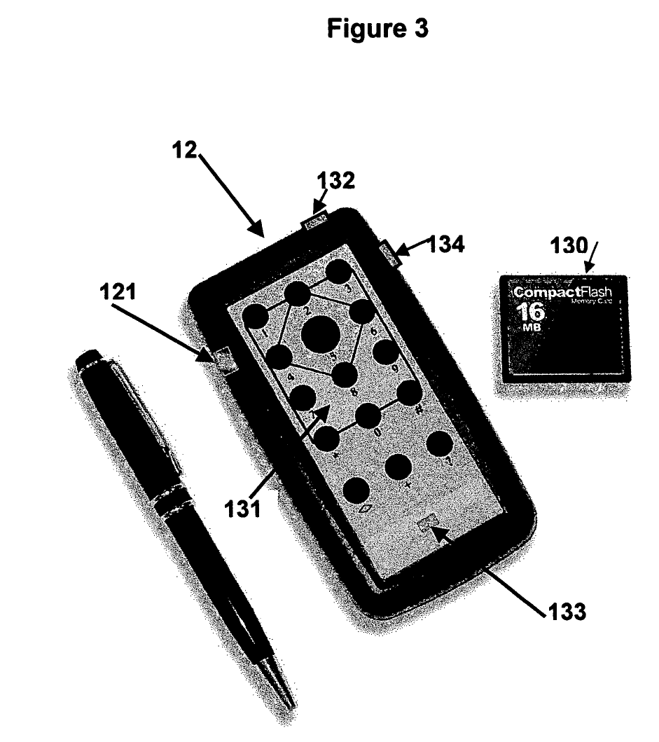

Referring to FIG. 1, a preferred embodiment of the Content Delivery and Speech System includes the Server 11 and Client 12 that are connected through a communications network. It also includes communication connections such as Internet connections from the Server 11 to one or more Content Providers 13, which may include, for example, magazine publishers 14, newspapers 15, book publishers 16 and/or other content providers such as Bookshare.org 17, an organization established specifically to provide talking books for the reading impaired. The input/output connectors on the Client 12 may also include a USB connection to a personal computer, and/or a dial-up modem with telephone (RJ-11) connectors, as discussed below and shown in more detail in FIG. 3.

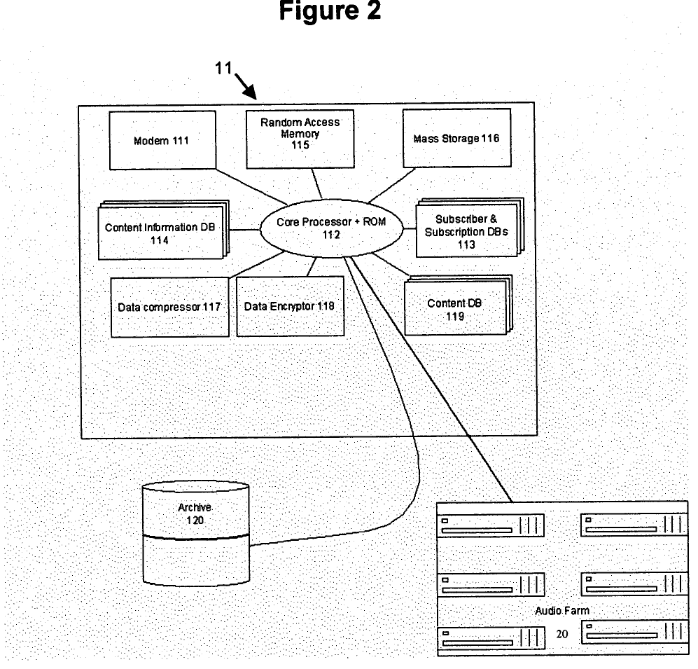

Referring to FIG. 2, the Server 11 may include any of several types of modems 111 standard in the industry and compatible with those of the Client 12, a core processor (with ROM) 112 which executes the primary control software and accesses random access memory 115 or a mass storage device 116, such as flash memory or a hard drive, a Data Compressor 117 and a Data Encryptor 118.

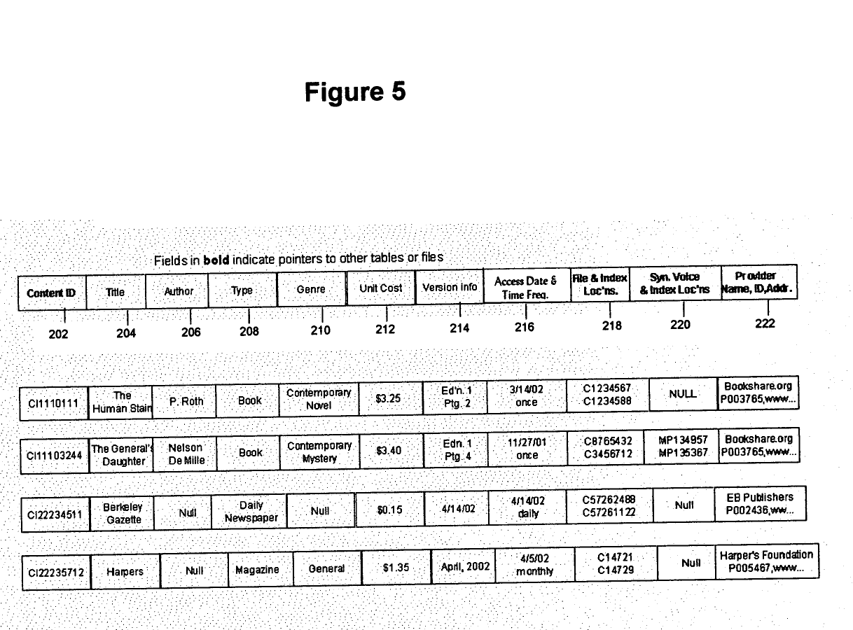

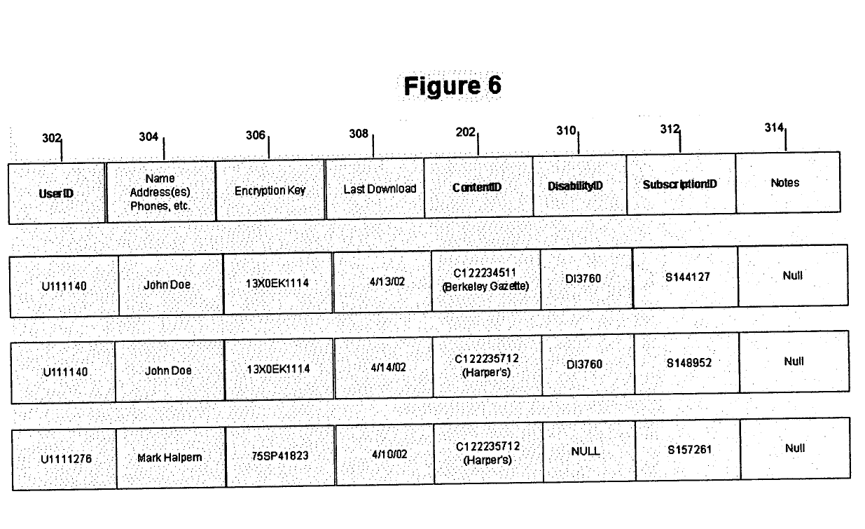

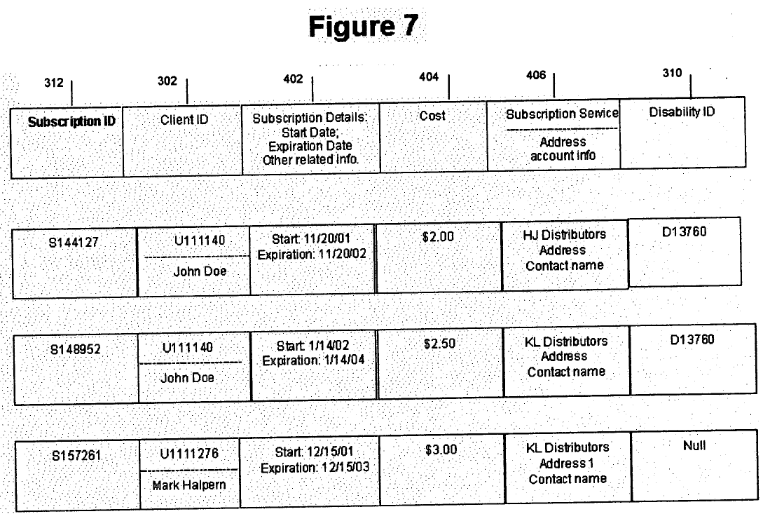

In addition, in the preferred embodiment the Server 11 manages a Content Information Database 114 whose records are exemplified in FIG. 5, Subscriber and Subscription Databases 113 whose records are exemplified in FIGS. 6 and 7, a Content Database 119 that includes files (documents) currently available for download to Clients 12, and an (optionally remote) Archive 120, which includes files previously downloaded and not current.

Additionally, the Server 11 may initiate and send jobs to an “audio farm” 20, which is a collection of computers connected to the Server 11 through a Local Area Network or other communications network. A task of the audio farm 20 is to receive digital documents which have been pre-processed on the Server 11 and which are then used as input streams on audio farm computers 20 equipped with the highest quality synthetic speech generators possible. These computers 20 produce MP3 or similar format audio files from the documents they receive, together with specially prepared index files to be used for navigation. This process is described more fully in the section on Server-Content Provider Process below.

The modem 111 provides one set of options for obtaining Content via Internet downloads. Another means of obtaining Content is to order a replaceable memory module 130 (such as Compact Flash) that slips easily in and out of its slot 121 on the side of the Client 12, as illustrated in FIG. 3.

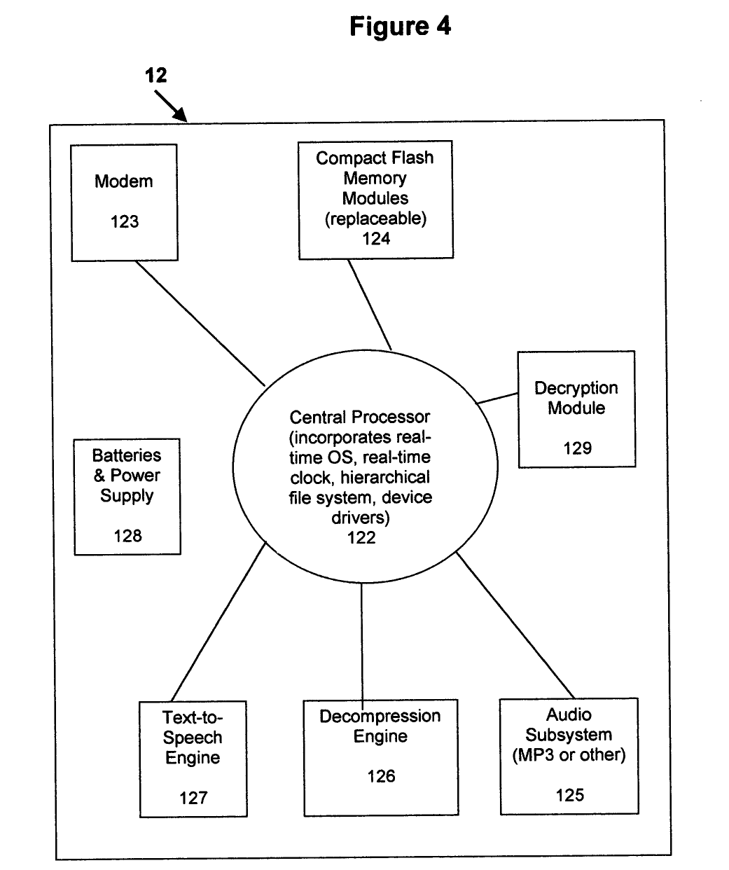

Referring to FIG. 4, the Client 12 may contain internally any of several types of modems 123 standard in the industry, including conventional 56K or other baud dial-up, USB or wireless, a processor 122 such as a Mitsubishi M30245 microcontroller with integrated USB device controller, a memory interface 124 such as a Compact Flash interface, static ram for data buffering and storage, flash memory for program storage and non-volatile data storage, a Micronas MAS3507 MP3 decoder and a real time clock/alarm. The MAS 3507D is a single-chip MPEG layer ⅔ audio decoder for use in audio broadcast or memory-based playback applications. Time Scale Modification of the MP3 output may be accomplished via an algorithm such as that disclosed in U.S. Pat. No. 5,175,769, the detailed description of which is incorporated herein by reference. Due to onboard memory, an embedded DC/DC up-converter, and low power consumption, the MAS 3507D is suitable for portable electronics.

The software and firmware may include, for example, a real time operating system from CMX Inc., an MSDOS compatible FAT file system and the actual application program which handles the user interface keys as well as controlling the sequence of processes that permit acquisition of content.

Referring again to FIG. 4, the processor 122 also communicates with a Text-To-Speech (TTS) engine 127 such as an RC8650FP from RC systems. The RC8650 is a voice and sound synthesizer, integrating a text-to-speech (TTS) processor, real time and prerecorded audio playback, and A/D converter into a chipset. Using a standard serial or eight-bit bus interface, ASCII text may be streamed to the RC8650 for automatic conversion into speech by the TTS processor. The RC8650's integrated TTS processor may incorporate RC Systems' DoubleTalk™ TTS technology, which is based on a patented voice concatenation technique using real human voice samples. The DoubleTalk TTS processor also gives the User real-time control of the speech signal, including pitch, volume, tone, speed, expression, and articulation. The RC8650 is comprised of two surface-mounted devices. Both operate from a +3.3 V or +5 V supply and consume very little power. This chip set also runs Time Scale Modification (TSM) algorithms used to both speed up and slow down the audio signal generated by a TTS engine. The digital data generated by the chip set may be converted to an analog signal via a Micronas DAC 3550 digital to analog converter, which also contains a headphone amplifier. Text data may be transferred from the microcontroller to the TTS chip set via an asynchronous serial communication channel. Preferably, up to a 20 key user interface may be used.

Additionally, the Client 12 includes a Decompression module 126 and a Decryption module 129. The device also includes a power source 128 such as two AA batteries and a power supply that converts battery voltage to logic voltage. Other types and numbers of batteries, as well as solar power or AC adaptors, may be used. Alternatively, a practitioner in the field will recognize that the conventional alkaline batteries could be replaced by rechargeable Ni—Cd type batteries and an AC adapter. The choice of non-rechargeable batteries is not critical to the invention.

Referring to FIG. 3, the exterior of the Client 12 may include a keypad 131, a USB or other standard communications port 132, and a mini-microphone 133 for voice recognition. Optionally, through the USB port 132, the Client 12 can be attached to a conventional computer or a printer or to a Braille embossing device, as shown in FIG. 1. The computer-Client connection can provide one means of transferring Content to the Client 12, but it is not the preferred method because of the requirement for a computer and some technical expertise (see Sections III and IV). On the side of the molded plastic case, in a preferred embodiment there is a mini-jack 134 for connection to headphones or external speakers. In one embodiment, the Client 12 weighs approximately six ounces, and its size is approximately 2¾ inches wide×4⅞ inches high×1 inch deep.

Operation of the Client 12 in normal (stand-alone) mode includes using the keys on the face of the device to cause it to “read” (speak) a selected content file, and to navigate through the file or through the entire “Virtual Library” of structured folders and documents as the listener chooses, by using the navigation keys described below. The User may also adjust a variety of settings, which preferably include volume and speaking speed, and may request Talking Help by using the keys. User actions are confirmed by an appropriate announcement by the Client 12. Each document has several attributes and lists associated with it internally. For example, every document preferably has a Current Position pointer and a Bookmark List.

In the preferred embodiment illustrated in FIG. 3, the key layout is deliberately similar to that of a standard telephone keypad, with the addition of a row of three keys at the bottom of the pad.

Most of the keys are “context-sensitive” in the sense that a key does “the expected thing” depending on the type of file selected. This is described in detail in Section IV of the Detailed Description. Conceptually, the files reside in folders much like the hierarchical file systems found in present day computers, although this is not emphasized to Users who may not be familiar with the concept. The collection of folders, subfolders and their files comprises the “Virtual Library” resident on each Client 12, as in FIG. 3.

Many of the common procedures involved with navigation have short cuts as described below. However, with the goal of simplicity of use, only a very few of the range of options available via the keys are necessary for operation of the device.

### II. Preferred Embodiment of the Server-Content Provider Process

In the preferred embodiment, the process may be implemented as a real-time task running on the Server 11 in an infinite loop subject to interrupts. In this embodiment, it is driven largely by the data in the Content Information Database 114. FIG. 5 illustrates examples of records and fields in the Content Information Database 114. In FIG. 5 (as well as FIGS. 6 and 7), fields in bold print indicate possible pointers to other tables or files. FIG. 5 shows records relating to four exemplary items, which may or may not be related to a single subscriber. The fields may include, for example, a Content ID 202, the title of the work 204, the author 206, a type 208 and/or genre 210, a cost 212, a version 214 and a content provider name 222, as well as information specific to the system such as access date, time and/or frequency 216 and file and index location 218 and 220. FIG. 6 illustrates example fields and entries for a Subscriber Database 113, where one subscriber receives two periodicals and a second subscriber receives one periodical. In FIG. 6, subscriber information may include, for example, a UserID 302, contact information (name/address/phone/etc.) 304, an encryption key 306, information regarding prior downloads (such as dates, time, descriptions, etc) 308, information relating to the User's specific handicap or disability 310, a subscription ID 312 and other information 314. FIG. 7 illustrates exemplary data that may be maintained in a Subscription Database 113 for the subscribers of FIG. 6. For example, such information may include the start and end date of the subscription 402, a cost 404 and service-specific information 406.

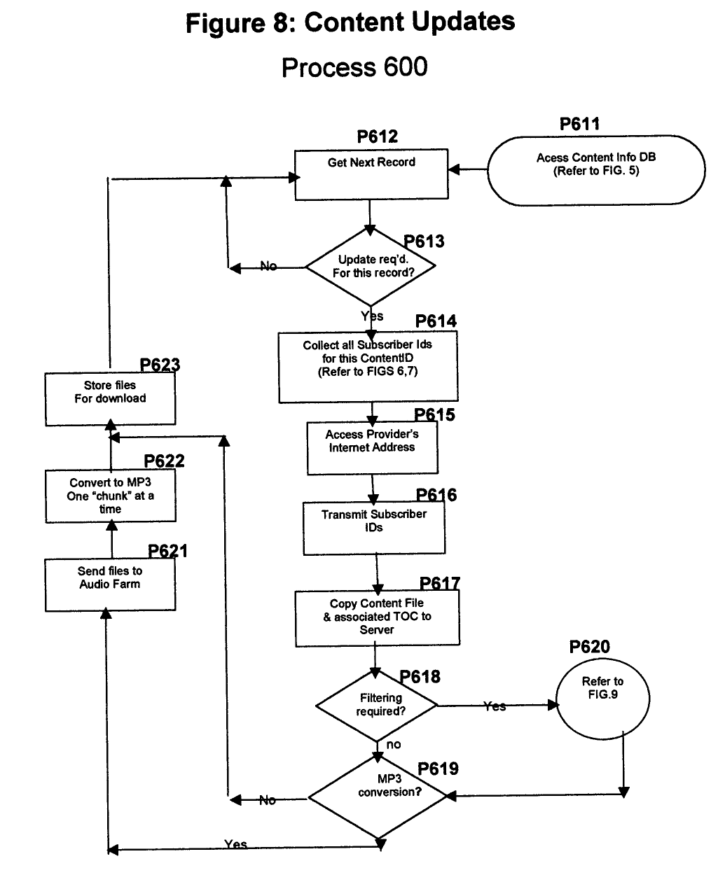

Referring now to FIG. 8, in an embodiment illustrated as Procedure P600, the Server 11 initially opens the Content Information Database 114 (such as that illustrated in FIG. 5) at step P611. It then preferably cycles repeatedly through all the records in that database P612. For each record, it determines whether an update is required P613 by using the Last Access Date/Time field and the associated frequency field 216 and comparing the former with a real-time clock. For example, a magazine may require downloading once a week, but some major daily newspapers publish several daily editions. In the latter case, the frequency may be hourly, for example.

If an update is not required, the process preferably examines the next record, going to the first one again after the final one is processed, in a cyclical manner. If it is determined that an update is required, the Process P600 first collects all the records in the Subscriber Database 113 for this particular ContentID 202 (such as that illustrated in FIG. 6), on the assumption that Content Providers 13 may require specific information about the subscribers for whom the content is being provided P614.

The Process P600 may then use information about the Content Provider 13 such as the Provider Internet Address field of FIG. 5 at step P615 to first transmit the Subscriber information P616 and then access the Content File and its Table of Contents file P617, both of which may be supplied by the Content Provider 13 by prior agreement. These two files are copied to a temporary workspace on the Server 11.

The Process P600 then terminates the connection to the Content Provider's site and next determines whether filtering is required P618 by checking for a legitimate pointer in the Filter field of the record. If the pointer address is NULL, no filtering is required. Generally, files may require filtering.

Filtering is the process whereby a formatted content file and its table of contents are transformed into an output file suitable for speech processing and associated index files for use in navigation. These files may then be stored on the Server 11 in anticipation of future downloads to subscribers.

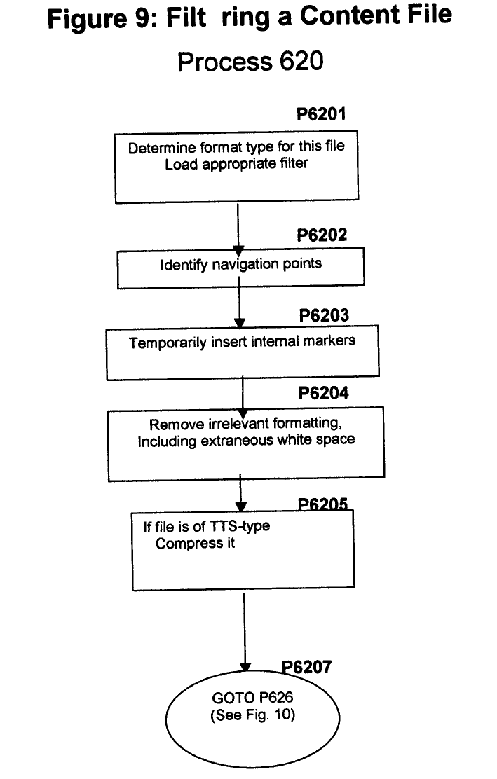

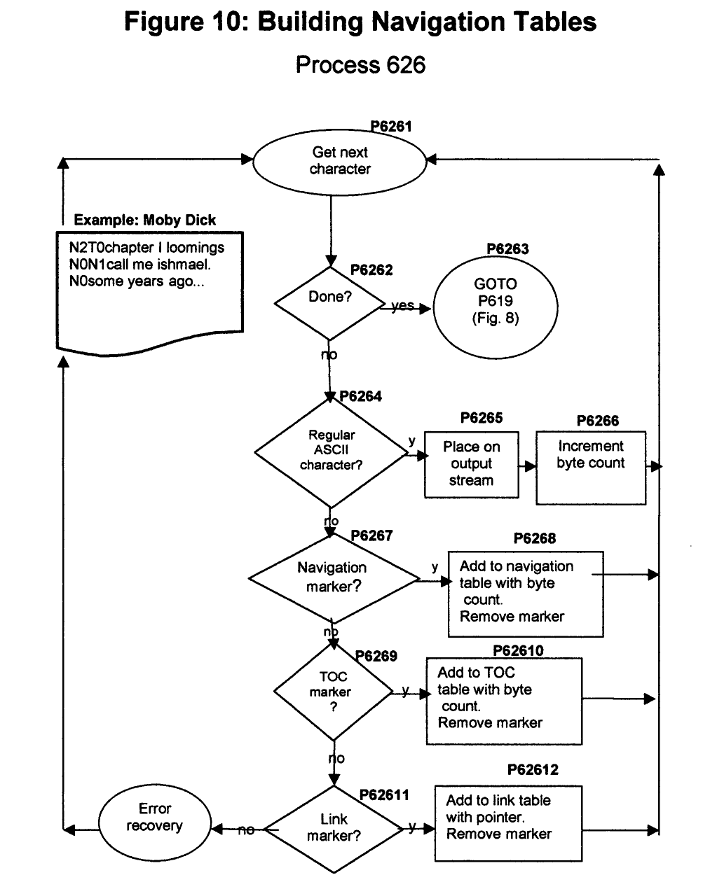

One skilled in the art will recognize that content may be provided to the Server 11 in many different formats (e.g., HTML, XML, Microsoft WORD, Appleworks, PDF, FrameMaker, DAISY, and so forth) and that each format will require its own filter. It is therefore impossible to provide an exhaustive description of such filters. However, the output from any such filter is preferably the same: a plain text file containing basic punctuation, and with extraneous white space and formatting removed, together with one or more files of pointers (indices) into the text file. The latter are used for user navigation within the document. FIGS. 9 and 10 represent preferred embodiments of the process without reference to a particular input format.

Referring now to FIG. 9, the content file is examined to determine the appropriate filter to be used at step P6201. The format type may be established through the use of a file name suffix, or through some other means, such as an identifier in the first line of the file.

The filter proceeds through the file, character by character, while performing one or more of the following tasks:

a) it identifies navigation points, which may include a table of contents if present, (hyper)links if present, as well as beginning-of-sentence, beginning-of-paragraph, beginning-of-page and any other higher level navigation points appropriate to the content (e.g., beginning-of-section for some documents) P6202;

b) it temporarily inserts internal non-printing characters at those same points P6203;

c) it removes irrelevant formatting, which may include font types, font sizes and extraneous white space P6204. The latter refers to any string of blank characters, including spaces, tabs or other control codes (ASCII 0×00 to 0×20) longer than a single blank. The filter also removes characters in the ASCII range 0×80 to 0×ff because they are reserved for the internal navigation codes.

d) If the file is to be spoken using Text-To-Speech, it is preferably compressed for efficiency P6205. A Huffman compression technique may be used, since it is lossless and permits decompression in the Client 12 in real-time (i.e., as the file is being spoken). The compression technique must preserve the relative locations of the special navigation characters.

The temporary markers representing beginning-of-sentence, beginning-of-paragraph, and beginning-of-page are denoted here and in FIG. 10 as N0, N1 and N2, respectively. In addition, if any (hyper)links appear, a special character, denoted here by L0 is placed immediately before and after the link. Also, if a table of contents is present, one of the special characters denoted here by T0, T1, T2 are placed at the beginning of each entry in the table depending on their level in the TOC. In addition, all characters are preferably converted to lower case.

At the conclusion of P6205, a new intermediate filtered file has been created, which consists of ASCII words with inserted (temporary) navigation markers. A word by definition is any string of printable ASCII characters including punctuation but not including a space. Optionally, the file may have been compressed.

The purpose of these navigation marks is to facilitate building the index tables for this content file in Process P626 (referring to FIG. 10). Several tables of indices may be created and they may include, for example: a Navigation Table; a Table of Contents (TOC); and/or a Link Table. These tables, together with the possibly compressed content file, may be available for downloading to Clients 12. For a given Client/Subscriber, the file may be encrypted using the Client's unique ID, thus guaranteeing that it cannot be used on any other Client 12 and helping to ensure the original Content Provider's digital rights.

The Navigation Table may include locations in the file that are computed using, for example, a count of bytes or of words. The TOC may consist of the words that constitute that particular entry in the document's table of contents, and the corresponding pointer into the file. The Link Table enables internal links within the document (which are always available) and links external to the document, which are potentially available either in the Virtual Library or via the Internet.

Referring to FIG. 10, a pass is made through the intermediate file, character by character. Each ordinary printable ASCII character is counted (P6264-P6266) and each navigation mark is identified and used to build the tables (P6267-P62612).

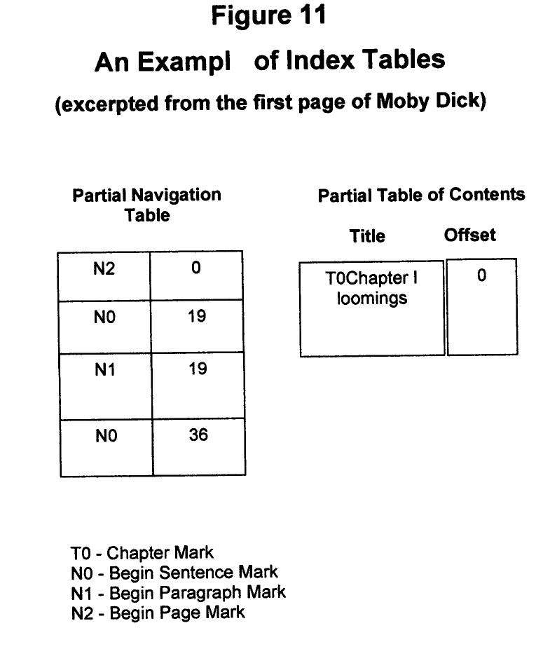

The first chapter heading and first sentence of Moby Dick are used in FIG. 10 to illustrate the process. The book is presumed for this purpose to include a TOC and the title may be used to make an entry in the TOC file. The byte offset to that location is shown as 0, since it is assumed here to be the first piece of speakable text. The first sentence is preceded by at least two navigation marks, for sentence and paragraph. Each of these is recognized in order at P6267 and placed in the Navigation Table with a corresponding offset of 19 bytes, which is the length of the preceding character string (exclusive of the special markers). The second sentence has only the beginning-of-sentence marker preceding it. FIG. 11 illustrates the two tables that result from just that short excerpt.

When all the characters of the intermediate file have been examined, the file is ready to be stored prior to Client downloads. If, in addition, it is to be converted to an MP3-type audio file, it is sent to the “audio farm” 20 for conversion. The conversion determination may be made by referring to the Content Information Database 114 (FIG. 5), where the Synthetic Voice field 220 indicates whether the additional conversion is required. For example, in FIG. 5, only the book “The General's Daughter” has been converted to MP3 format, as shown in the “Syn. Voice and Index” field 220 of its record.

The conversion to MP3 is preferably done a “chunk” at a time. As used herein, a chunk is a fragment of text contained between two consecutive navigation points. This facilitates the updating of the index tables to be consistent with the MP3 format, so that navigation works the same way on the Client 12 for either MP3 or TTS audio.

### III. Preferred Embodiment of the Server-Client Processes

The function of the Server-Client Process is to download material to the Client 12 from the Virtual Newsstand on the Server 11. Typically, this material will include periodicals to which the User has subscribed as well as books and other published documents. Preferably, the downloads may be in at least one of, for example, two forms: (1) standard digitized material and its associated index file, suitable for real-time speech synthesis and navigation on the Client 12; or (2) higher quality audio-formatted content with its index file. In both cases, the use of the material is the same; the differences are only in the quality of speech between the two modes, and the time lag inherent in the process of producing the higher quality audio source on the Server 11. In an embodiment, the Server's actions for these processes may be dictated almost entirely by the relevant contents of the Compact Flash card 130 contained in the Client 12. Thus, this card 130 may play a central role and the procedures may be driven by the data on the card, as interpreted by the System's software.

At least four methods of Client-Server contacts are available: a) automatic dialup from the Client 12, using the real-time clock to schedule such events; b) dialups manually initiated by the User; c) download from a PC connected to the Internet; d) replacing compact flash memory cards in the Client 12 with updated versions which arrive periodically by conventional mail service.

Method (d) is the preferred method at the present time. It has major advantages with respect to the target group of Users: It is “low-tech”, easy to use and understand and avoids the need for either a PC or broadband Internet connection. Furthermore, it differs from the other three methods only in that the compact memory card is updated at a location other than in the Client 12 itself. In all other respects, the four methods are essentially the same; only the connection process is different. Therefore, method (d) is described below.

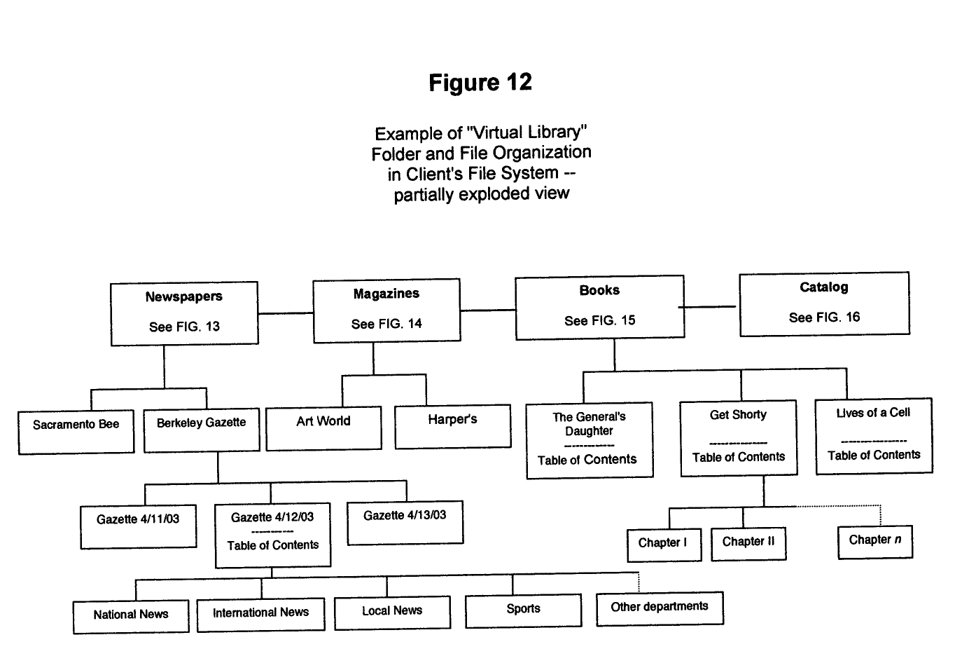

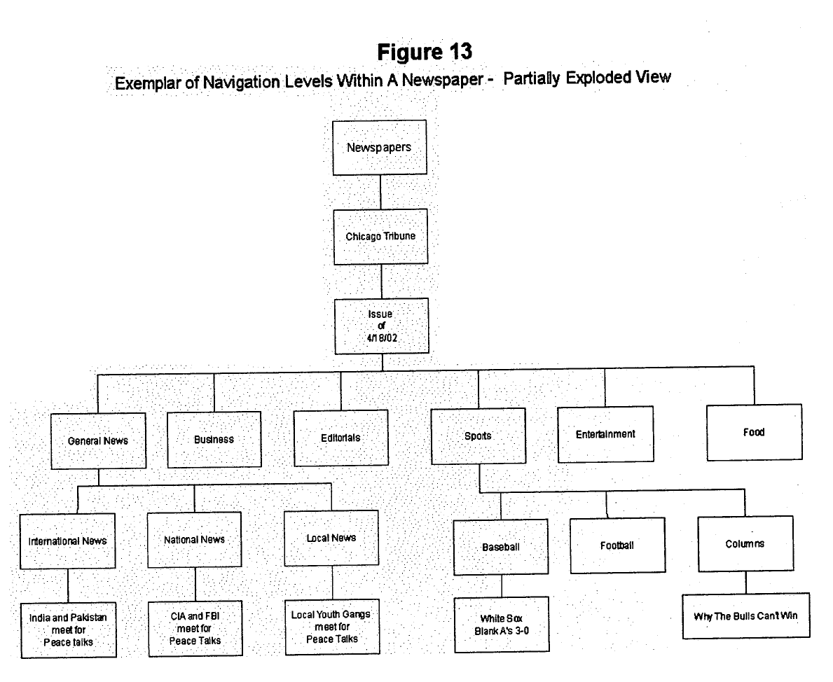

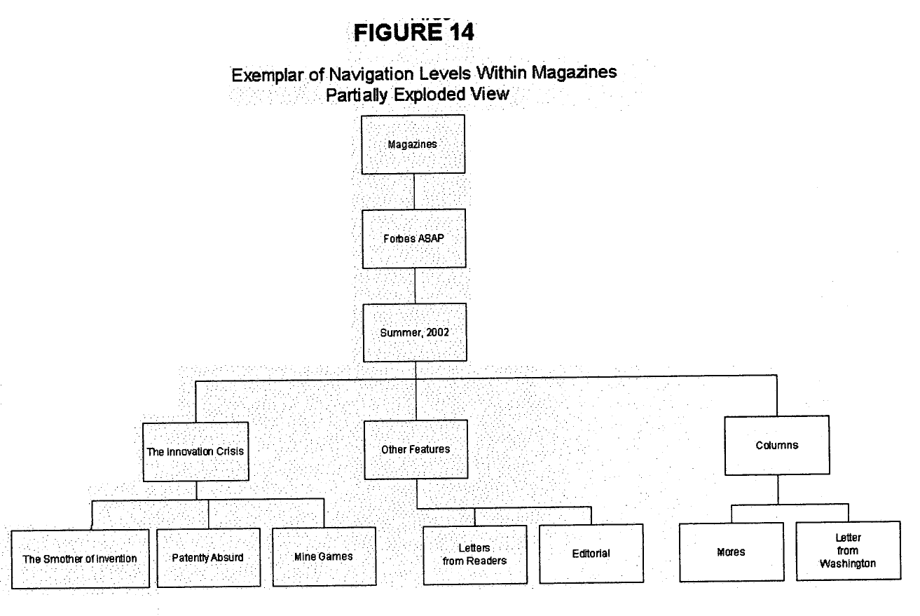

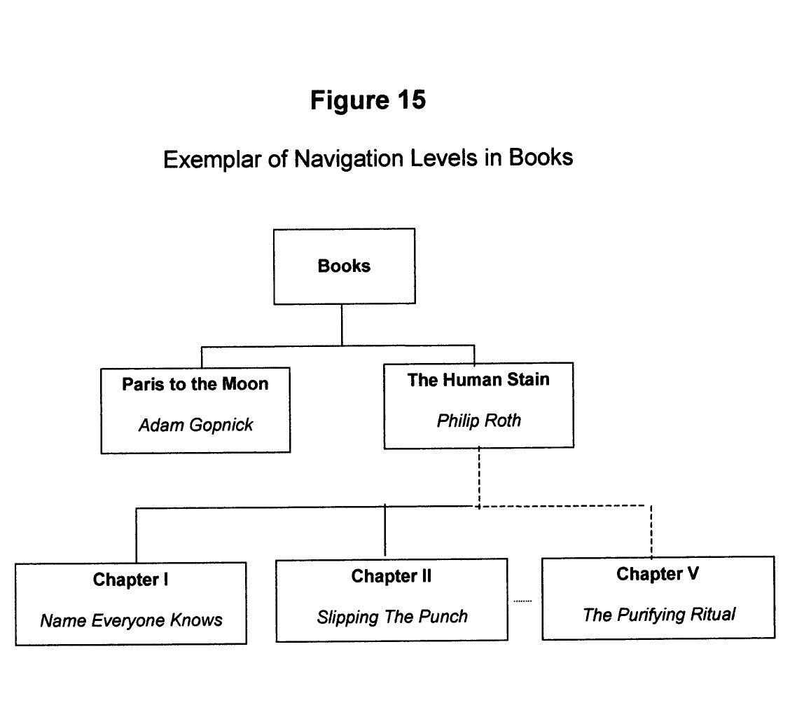

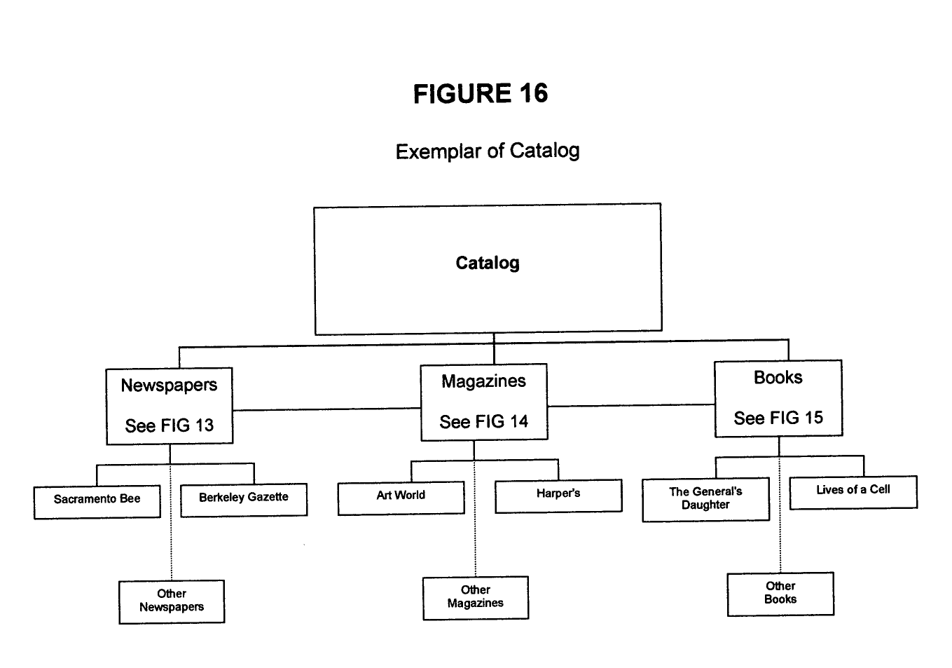

When a User first receives a Client 12, it may arrive with a second, preferably identical compact memory card 130. Each card 130 may preferably have at least the first level of folders shown in FIG. 12. The specific types of folders listed are preferred, but not required. The first three folders—newspapers, magazines and books—may contain samples of documents and/or the first installments of material initially ordered by the User. Exemplary navigation levels within these types of folders, with exemplary content entries, are illustrated in FIGS. 13 (newspapers), 14 (magazines) and 15 (books). In addition, in a preferred embodiment the fourth top-level folder—the Catalog folder—may contain the complete Catalog of publications available either through purchase, subscription or for free (public domain). The preferred Catalog file structure is illustrated in FIG. 16, using exemplary title entities, and it may resemble the top two levels of the file system shown in FIG. 12. In other words, only titles of the content may appear. If a title is selected, a short “blurb” of information, including ordering information, may be announced for that item.

Thus, the User may browse the Catalog at any time, and “check mark” items of interest, using the procedures described below in Section IV. The Catalog may contain, in addition to the “blurb,” the correct pathname for the content file to be delivered. This may occur because the Catalog itself mirrors the structure of the content part of the file system.

At any time, the User may then remove the memory card and mail it to the Server address with new requests and billing information embedded. The duplicate memory card may then replace the original and may be used until a new one arrives in the mail.

If the update process described below is performed remotely via an Internet connection, the only difference may be that a second, duplicate memory card is not needed.

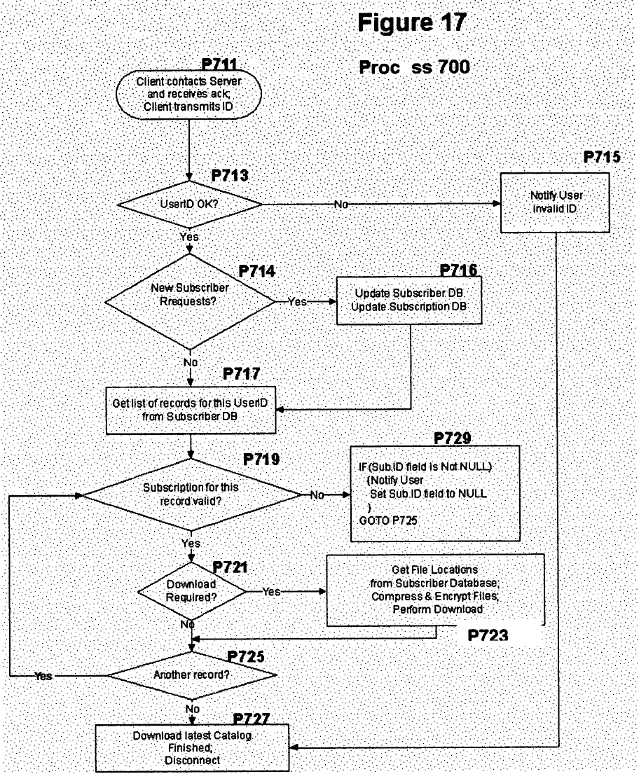

Referring now to FIG. 17, in a preferred embodiment of the content download process 700, the Client 12 may initially contact the Server 11 either over the Internet or from the remote Client 12. The Server 11 acknowledges the contact P711 and requests the unique User ID 302. It is transmitted in encrypted form to preserve the User's privacy and to ensure the security of the entire subscription process for the Content Providers 13. The Server 11 proceeds to verify the ID 302 at step P713 by checking it against the list in its Subscriber Database 113 (see, e.g., FIG. 6). If the ID 302 is invalid, the Server 11 may transmit an audio advisory message to the Client P715. If the ID 302 is valid, the process checks to see whether the User has made new requests in the manner described above, beyond the ones he may have previously specified P714. That is, any time that the User contacts the Server 11, he may order new items from the Virtual Newsstand by using the embedded Catalog.

If there are such requests, they are processed at P716 by appending new records to both the Subscriber Database 113 (such as that shown in FIG. 6) and the Subscription Database 113 (such as that shown in FIG. 7). Since the User is already registered, at least one such record for her is already in the Subscriber Database 113. Thus, adding additional ones is a matter of filling in the record fields from existing information, and using the Content Information Database 114 to fill in the ContentID field 202. A new, unique Subscription ID 312 is also generated for each new request, and the Subscription Database 113 has new records added to it in much the same manner.

Whether or not there are new requests, all records in the Subscriber Database 113 for this UserID 302 are preferably collected at step P717. Step P719 verifies that the subscription for this item is valid by accessing the Subscription ID field 312 (FIG. 6) and using it as a key to find the corresponding record in the Subscription Database 113 (FIG. 7). The second set of fields in the latter record serves simply as an additional verification check. The Process 700 then checks the Expiration Date 402 for this subscription to verify that it is still in effect. If it is not, the User is notified the first time the subscription date is found to be expired at step P729, and the Subscription ID field 312 is assigned a null value in the Subscriber Database 113 until such time as it is reinstated.

If the subscription is valid, the process returns to the current Subscriber record (FIG. 6) at P723, whose Content ID fields 202 point in turn to the appropriate records in the Content Information Database 114 (FIG. 5), from which the locations of the Content File and its Index Files 218 are obtained. These files can then be downloaded to the Client 12 while processing of additional records continues at P725.

Whenever such files are transferred to a Client 12, whether by the preferred method or any other method, the files may be decrypted using the unique key related to the Client's processor. Decompression is done “on the fly”—in real time—as the document is spoken (refer to Section IV below).

Because all subscription information for this Client 12 is available in the Subscriber Database 113, correct pathnames for each downloaded file are available. On download, the Client 12 examines the pathnames of the files and updates its internal directories. Typically, the Client 12 will receive a new Catalog folder as part of each update, so that new publications will always be available for order.

After all records for this Subscriber/Client have been processed and the files downloaded, the Server 11 terminates the connection to the Client P727.

### IV. Preferred Embodiment of the User Interface Processes

Terminology

The Client 12 may read documents and lists. Documents include content items such as books, newspapers, magazines, and generic text files. A document may contain readable text that may or may not be organized in a structure that the User can navigate. The structure may be a hierarchy of items where every item has a title and, optionally, some readable text. The User may listen to the document continuously, or he or she may jump through it using the hierarchy.

A list is a hierarchy of documents, preferably organized by title. A list may be read continuously, or the User may navigate through the titles or items on the list. The kinds of lists may include a Library (a hierarchy of all the available documents as well as some system information as depicted in FIG. 12), a Table of Contents (for individual documents), a Bookmark List (for each document), a Settings List (for personal preferences having to do with the voice used by the device), and/or a Favorites List (a list of most commonly used documents).

When the Client 12 reads a document or list continuously, it may read one hierarchy item after another based on the item organization defined by the hierarchy. Preferably, the Client 12 first reads the item title and then the associated text, if any exists.

Below the item level in a document, up to four additional levels may exist: page, paragraph, sentence, and word. Newspapers and magazines may not have pages, but books and generic text files may have them. The User may access these levels through the Navigation keys in the manner described below. In contrast to documents, a list may only have one navigation level below the item level: word. In general, the User may not traverse a list by page, paragraph, or sentence, although an embodiment that provides such functions to the User is not excluded from the scope of the invention.

Notation and Conventions

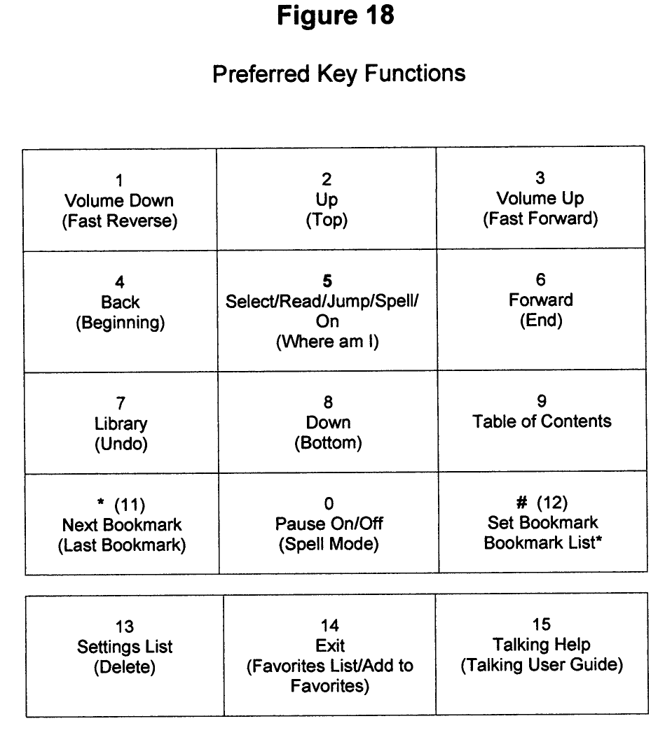

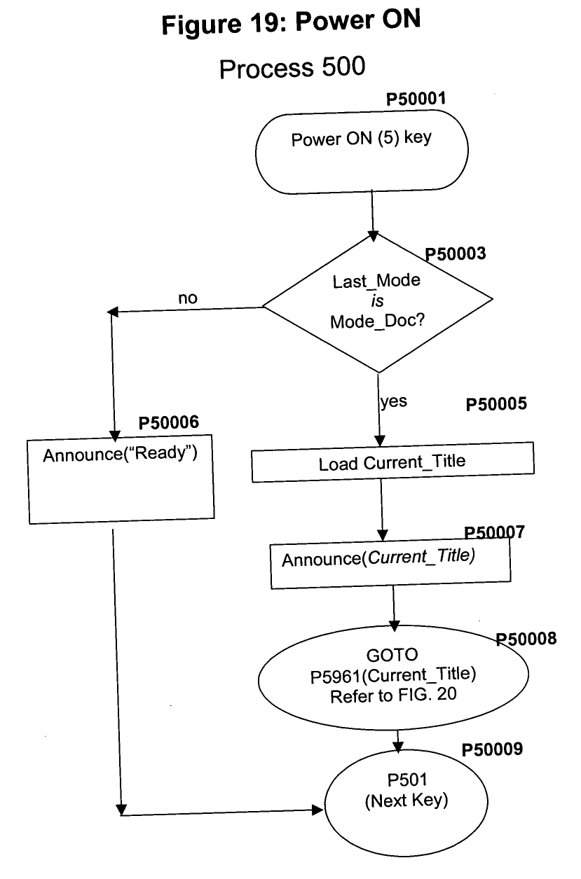

In the paragraphs that follow, numbers and symbols in parentheses refer to the keys represented in the table of FIG. 18. A secondary mode assigned to a key is preceded by a hyphen. For example, (7-2) refers to the secondary mode of key 7. To access these secondary functions (shown in parentheses in FIG. 18), the User may simply hold down the corresponding key approximately two to three seconds until a “beep” is heard. Other lengths of time and other signals (or no signal at all) are also within the scope of the invention. The same conventions are used in FIGS. 19-39. Many of FIGS. 19-39 include a key code X.Y, where X is the number of the key (from FIG. 18) and Y is either 1 or 2 depending on whether the primary or secondary function is selected. Exceptions are figures that represent routines not directly accessed by a single key, such as the power on function illustrated in FIG. 19. Note that the keys illustrated in FIG. 18 and the selection of various functions as primary or secondary are merely intended to serve as an illustration. Other key configurations are possible.

The structure of the Virtual Library as shown in FIG. 12 can be represented as a two dimensional array. Therefore the n-th item at the m-th level in the Virtual Library may be represented as the numerical couple (m,n). For example, (3,1) identifies the Berkeley Gazette of Apr. 12, 2002 in FIG. 12. This convention is used in the flow charts and representative code contained in FIGS. 19-39.

Other lists, such as the Table of Contents for a document or a Bookmark list are simple (one-dimensional) lists and require only a single numerical parameter to designate a location in them.

Navigation and Modes

Navigation refers to User-initiated moves either from one document to another within the Virtual Library (or the World Wide Web), or from one location to another in the same document. While the differences are transparent to the User, internally the Client 12 may use the hierarchical file structure to move within the Virtual Library, and an individual document's Table of Contents and its index files for moves within a document (refer to Section II above). This transparency may provide simplicity of operation and may be achieved by the use of modes in the control software.

Modes are certain states of the device that are set either by the User or more often by the device itself. Like most of the conventions and details in this section, their existence is preferably transparent to the User, except for Pause mode. Modes may provide context for actions. For example, a navigation key may be used to move through either the Library or any other selected list. Modes may include Document Mode and Pause Mode, among a multiplicity of modes. Several modes may exist simultaneously (e.g., List Mode and Pause Mode). When the User navigates to a readable item, the Client 12 automatically returns to Reading Mode. The Client 12 then reads the current document continuously from that item onward.

Methods for Navigating Through the Virtual Library

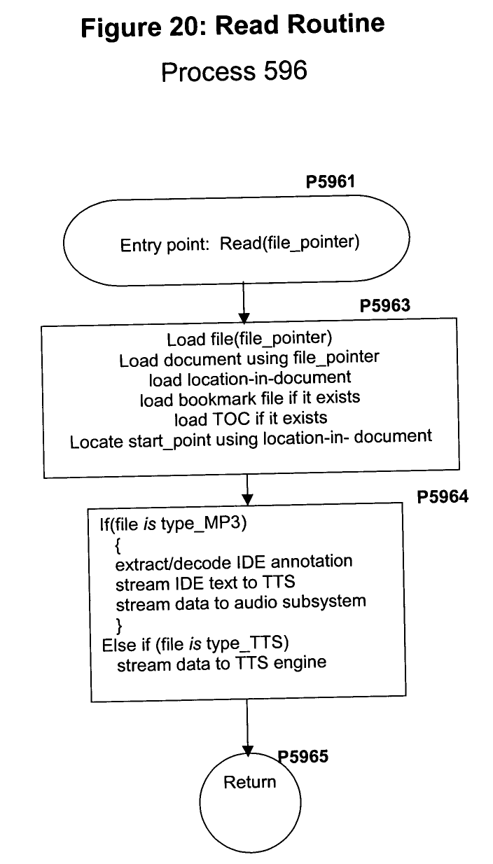

Referring now to FIG. 18 for the layout and function of the keys and to FIG. 19 for Process 500, a User powers ON the Client 12 by pressing the On/Read/Select key (5) once P50001. Preferably, the device first determines if a document was in the process of being read at the prior Power OFF P50003. If that is the case, the Client 12 may load the current title P50005, announce the current title P50007, and proceed to load the document from there P50008. The preferred READ routine, illustrated in FIG. 20, loads the file pointer to the document, the document and its associated files using the file pointer, and determines the location in the document at which the User left off P5963. Next, the READ routine determines whether the file to be spoken is of MP3 format (or another audio format) or ordinary text type at step P5964. If the file is an audio format content file, it may search the file for annotations. For example, many MP3 files include annotations of a type known as ID3 to provide listener information for MP3 files. For example, if an MP3 file is of a song, the ID3 data may include information such as title, album, performer, lyrics, genre, etc. The READ routine may route the annotation to the TTS engine 127, where it is converted to an audio format. The audio format data may then be routed to the MP3 or other audio system output 125. If the file is of text type, the data may be streamed directly to the TTS engine 127. The routine then returns to its calling process at P5965.

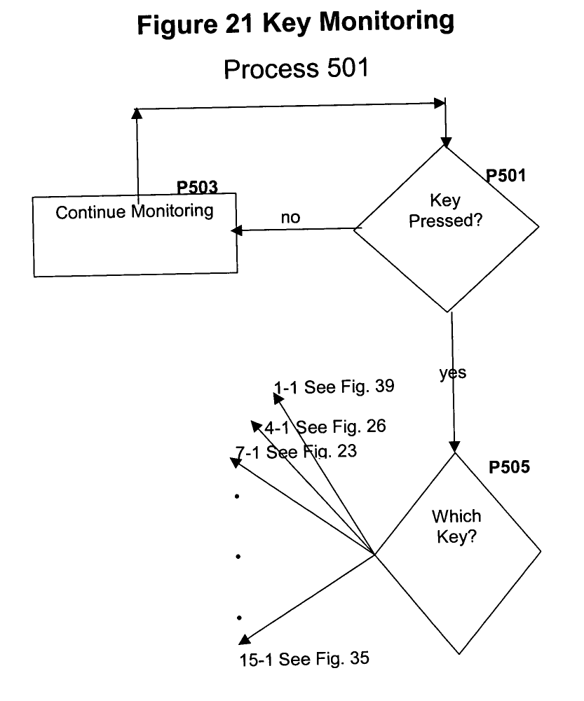

Referring to FIG. 21, the multi-tasking operating system returns to the main key monitoring routine P501 to wait for the next key interrupt. If the device was not in document mode at the time of the Power OFF, the device simply waits for the User to press another key P503. Once the User presses a key, the system moves to the appropriate routine at P505.

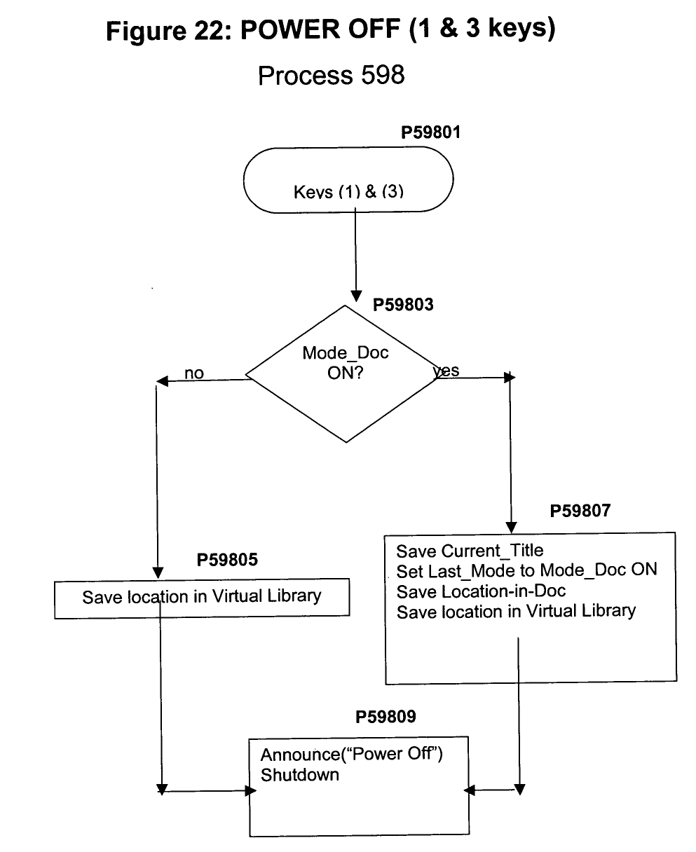

As shown in FIG. 22, to turn the Client 12 OFF, in the illustrated embodiment the listener presses the (1) and (3) keys simultaneously (step P59801). This may prevent accidental turn-off. The device first checks to see if a document is currently selected (P59803). If it is, the title of the document, the location of the current sentence in the document and/or the current mode are saved (P59807). Otherwise, just the current location in the Virtual Library is saved. The device is then powered down by the operating system at P59809.

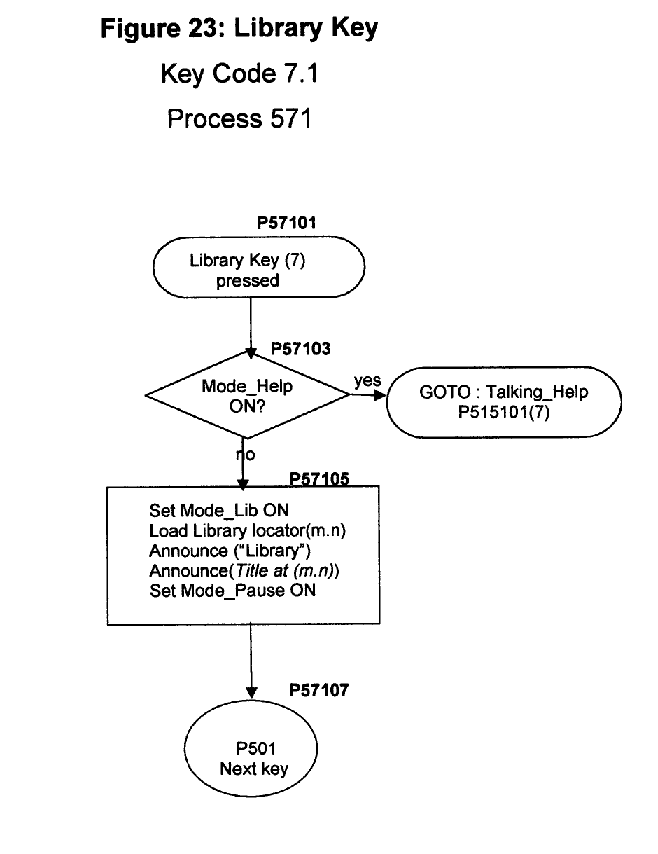

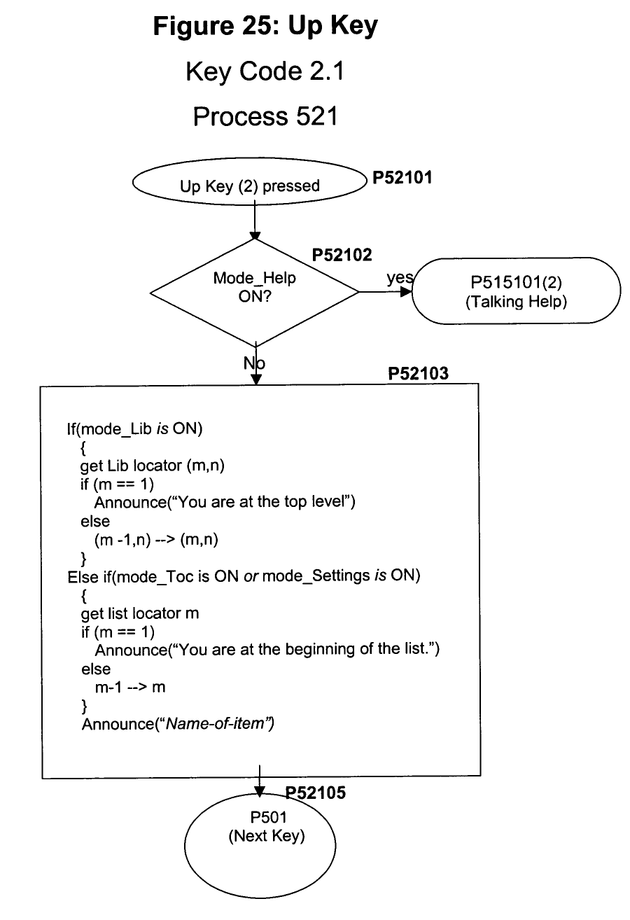

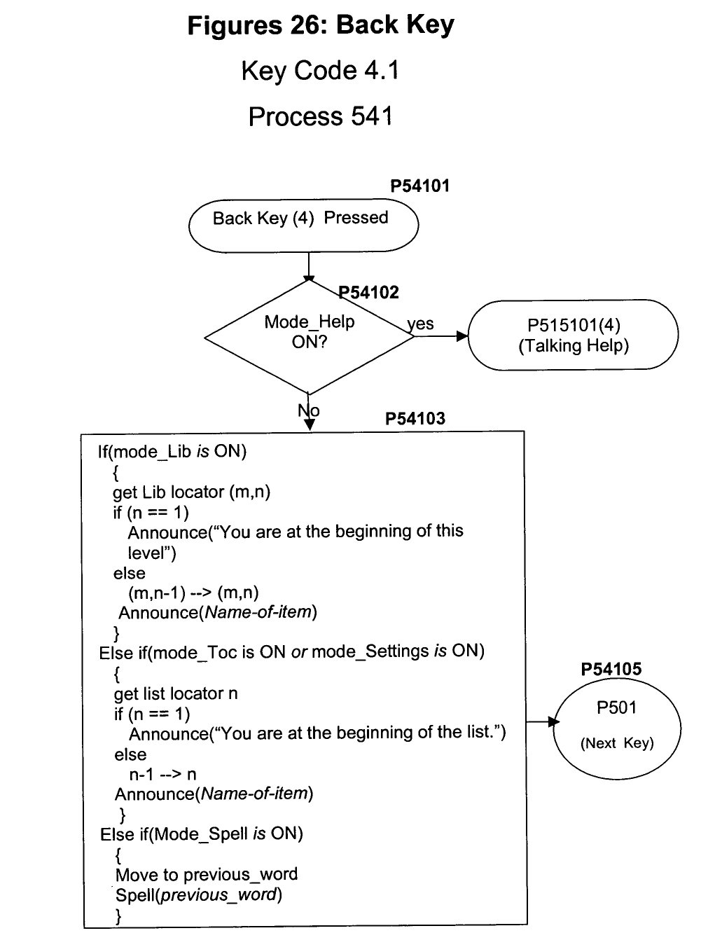

To choose a new document, the User may press the Library (7) key (P57101 in FIG. 23). As shown in step P57103 and in other figures in this series, the device preferably first checks to see if Talking Help is requested. Returning to FIG. 23, at P57105 the device announces the current location in the Virtual Library and pauses while waiting for the next key to be processed. The listener may then browse the entire folder hierarchy of FIG. 12 by using the Navigation keys (e.g., 2, 4, 6 and 8). Pressing the up (2) or down (8) keys moves one from the current level to a higher or lower one (vertically in FIG. 12). FIG. 25 illustrates an exemplary protocol for moving up a level. Pressing the back (4) and forward (6) keys moves one back and forward along a given level (horizontally in FIG. 12). FIG. 26 illustrates an exemplary protocol for moving back.

The same keys may be used to navigate through a Table of Contents or Bookmark List or any other list by the use of modes, as described earlier in this section. They may also be used to navigate within a document as well, using the Index Tables described in Section II.

For example, and referring again to FIG. 12, turning the Client 12 on the first time and pressing the Library key causes the Client 12 to announce “Newspapers.” Pressing the Navigation Down key once, then Forward once then Down again brings the User to the Apr. 12, 2002 issue of the Berkeley Gazette. At each step, the Client 12 announces the name of the folder or document and waits for the next key push.

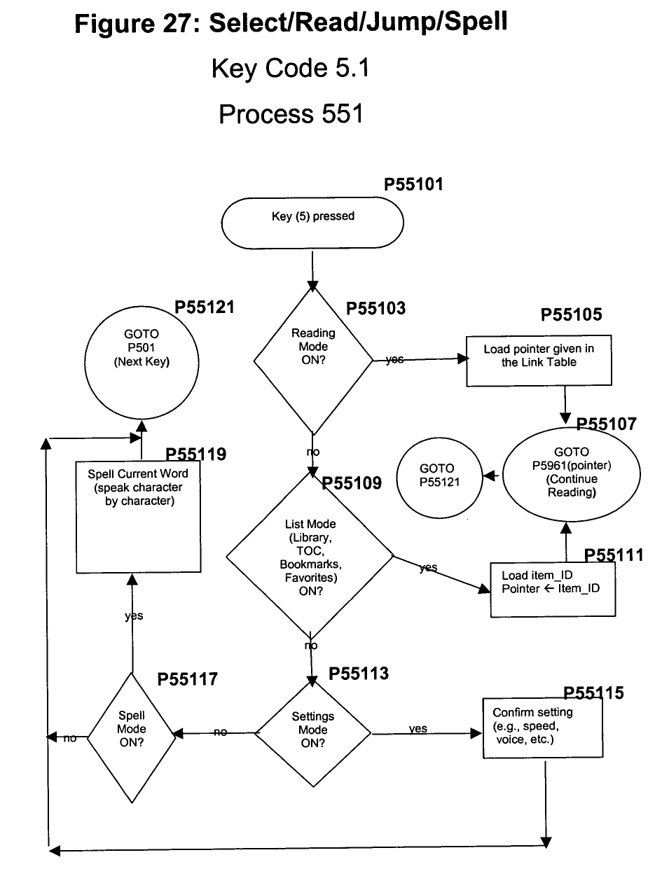

As another example, if a book is being read, the User may first press “Pause” and then navigate with the same keys. When the User presses the “Up” or “Down” keys, the Client 12 may announce “Page n ” or “Paragraph/Sentence/Word Level” and then pause. If the User navigates back or forward (4 or 6 keys) on the page level, the Client 12 may announce “Page n−1” or “Page n+1” and then pause. Similar announcements may be made at the paragraph, sentence and word levels. On the word level (which is derived indirectly from the navigation tables), the Client 12 may speak each word and pause. At this level, the User may then press Select (5) to spell the current word. Refer to FIG. 27, P55117.

Preferably, all document titles in a list are Jumps (in the sense of web browser hyperlinks) to that location in a document. The Client 12 indicates that an item in the Library is a document by changing the reading voice. A document is selected by pressing the Select (5) key (FIG. 27, P55101). The Client 12 begins reading the selected document at the last reading position P55107 or at the beginning P55111, if this is the first time the User has listened to it.

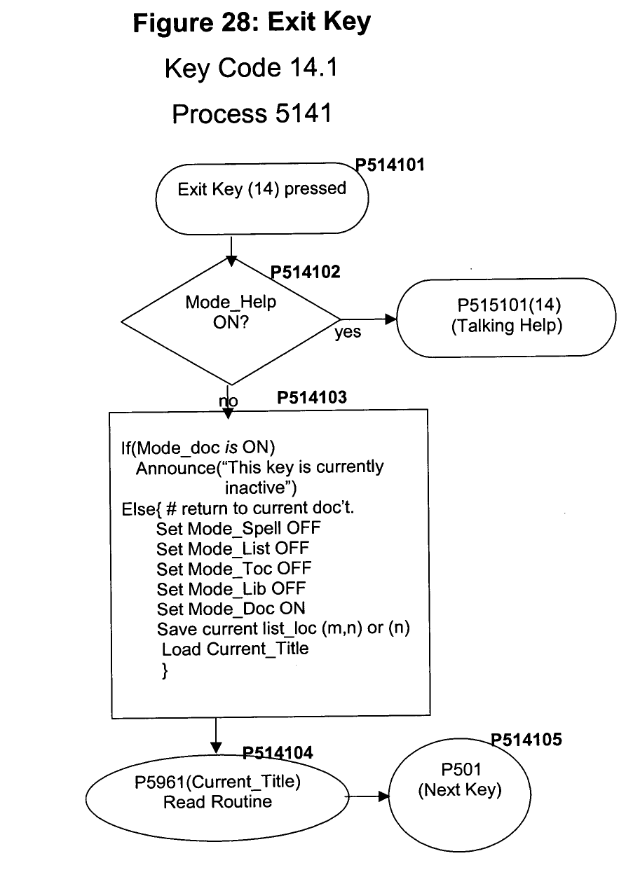

To exit the Library and return to the current document without selecting another, one presses the Exit (14) key (refer to FIG. 28). At step P514103, the device resets the modes and saves the current location within the current list, if any. It then returns to the most recent document at P514105 and continues reading where it left off, while waiting for a key interrupt.

Navigation Options

A number of options are preferably available to simplify navigation. A hidden system folder that contains a Favorites List (14-2), a Settings List (13), a Talking User Guide (15), Bookmark Lists (12-2), and/or a list of Tables of Contents (9) may be used to provide a multiplicity of other options for a User. The Favorites List, Settings List, and Talking User Guide may be accessed by pressing the keys, such as those illustrated in FIG. 18. The system folder is transparent to the User.

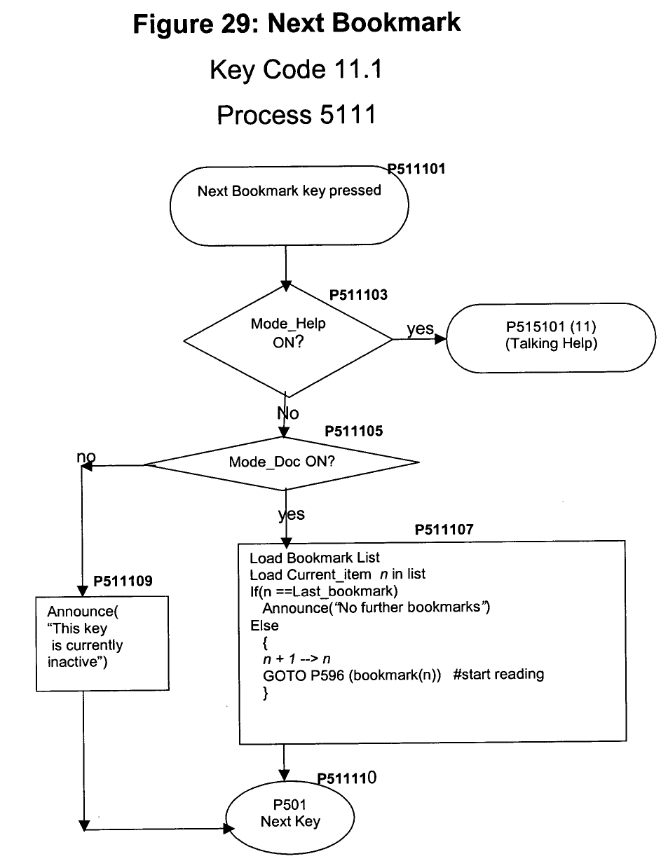

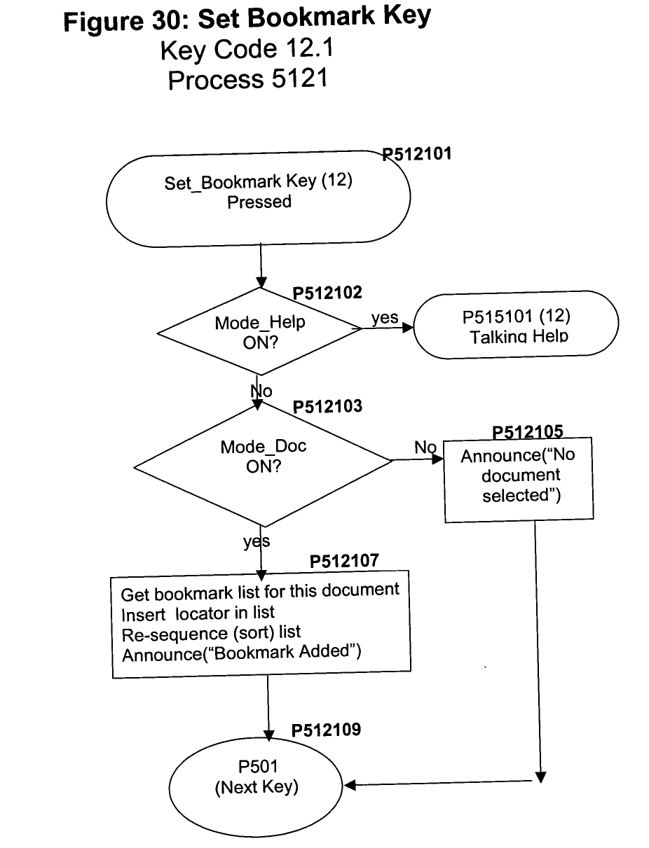

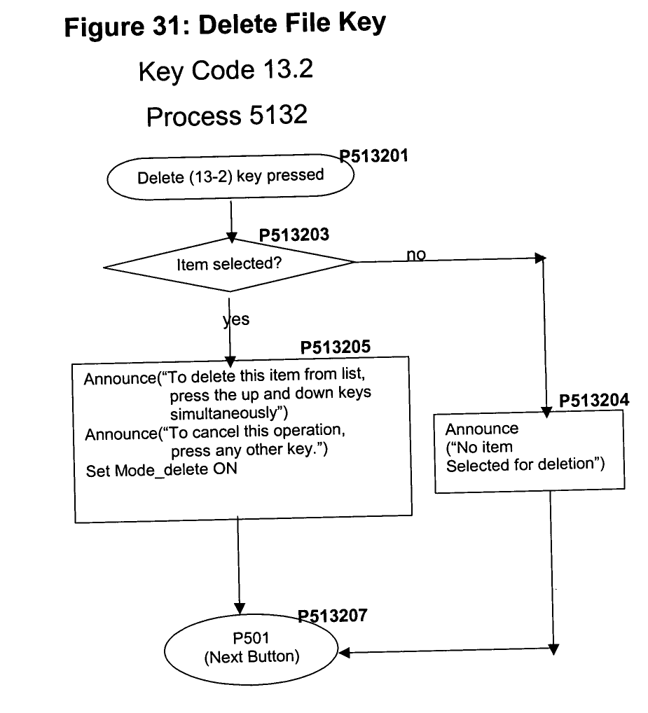

The Bookmarks folder contains a list of the library documents that have defined bookmarks. When the User selects a document title, the Client 12 may load the associated Bookmark List as well. The User may select a bookmark and jump to the appropriate location within the document using the Next Bookmark/Last Bookmark (11) key (FIG. 29), can set bookmarks in a document using the Set Bookmark (12) key (FIG. 30) and delete them using the Delete (13-2) key (FIG. 31).

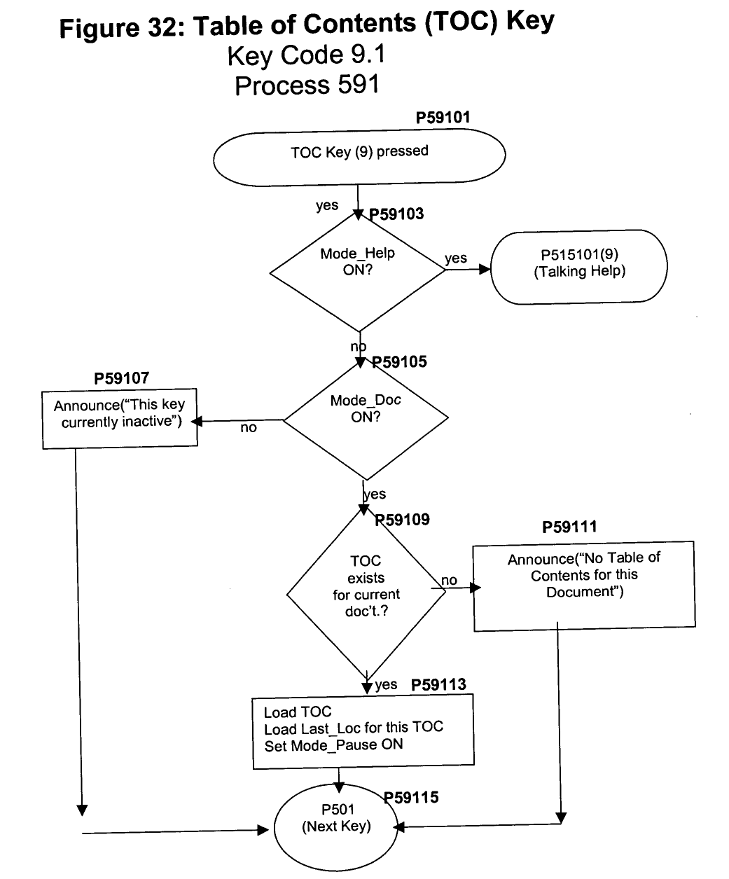

The Tables of Contents (TOC) folder similarly contains a list of the library documents that have Tables of Contents as prepared in Section II above. (Not every document will necessarily have a TOC.) For each individual document, the listener may press the Table of Contents (9) key when a document title is announced. See FIG. 32. The listener may hear the TOC line by line, beginning to end, or elect to navigate from one level to another within the table using the navigation keys (2, 8). For example, a TOC for a book may consist merely of chapter titles, while a TOC for a magazine may generally be more complex, as in FIG. 12.

Preferably, each item in the TOC is both a title to be read and a Jump to the associated navigation point in the document selected, as indicated in FIG. 11. Each file name in the Virtual Library may also be a Jump. Pressing the Read/Select/Jump (5) key after the name of a particular Content File is spoken may take the listener to that file and initiate the speaking of the file. (Refer to FIG. 27). After finishing the file, the Client 12 may automatically return to the previous location in the Virtual Library.

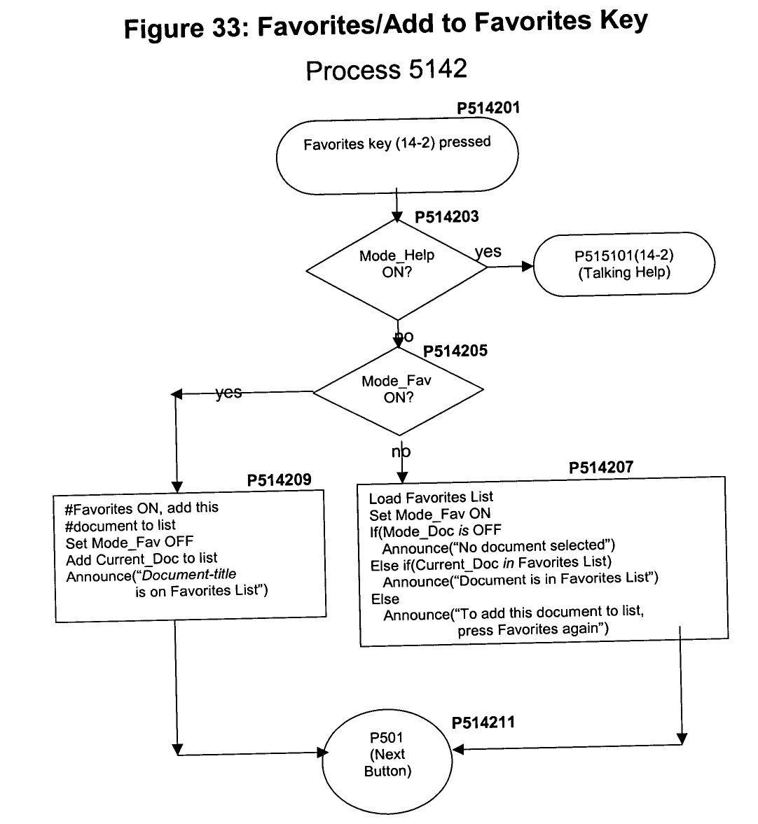

The User may reach a document more directly if it has been previously placed on the Favorites List, accessed via the (14-2) key (FIG. 33). The User may navigate through the list using the Back and Forward keys (4,6). All documents in the list may be Jumps. The User may go to the selected document by pressing Select (5). (Refer again to FIG. 27). The Client 12 may begin reading the document at the last reading location.

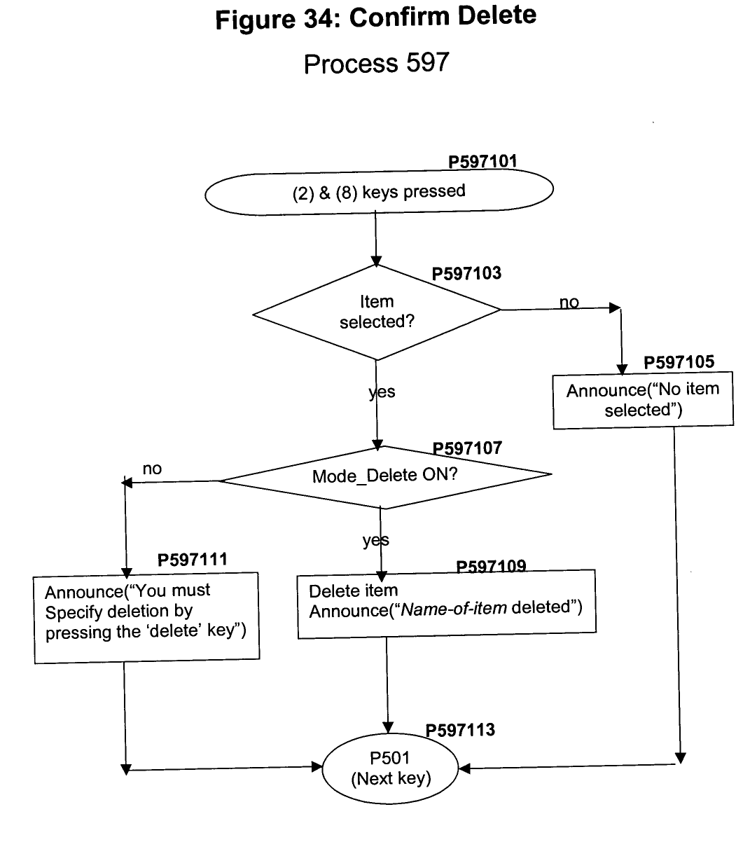

With the Favorites List loaded, the User may press the Favorites List key again to add the current document to the list P514209, as in FIG. 33. The Client 12 may confirm the action by announcing “Document Title is now on the Favorites List.” The User may delete documents from the list using the Delete (13-2) key in this embodiment, as in FIG. 31. The delete function may be confirmed as illustrated in FIG. 34.

In this manner, the User may navigate between documents, articles and categories through the entire Virtual Library, including the Catalog. The next section describes the options available to the User once a document has been selected for reading, in addition to those already described.

Reading Options

In a preferred embodiment, when a document has been chosen for reading by one of the methods described above, the Read (5) key is pressed to start. The Client 12 speaks the text until the document is finished or is interrupted by a key push. It is transparent to the User whether the document type is TTS or Audio. That is determined automatically by the file type.

Although the process of reading may be no more complicated than that, a multiplicity of options are available for that the User to choose at any time. In a preferred embodiment, they may be placed in three broad categories:

1. Help Functions—including “Talking Help” and “Where am I?;”

2. Environmental Settings;

3. Reading Aids, examples of which include “Pause”, “Next/Previous Word”, “Spell Next/Previous Word” and “Undo.”

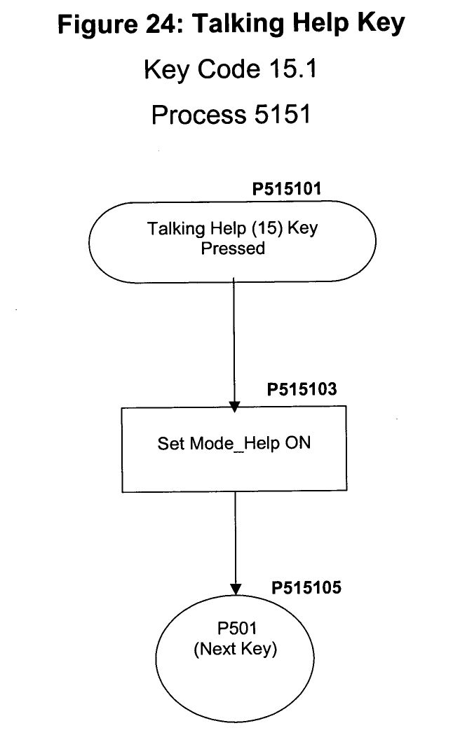

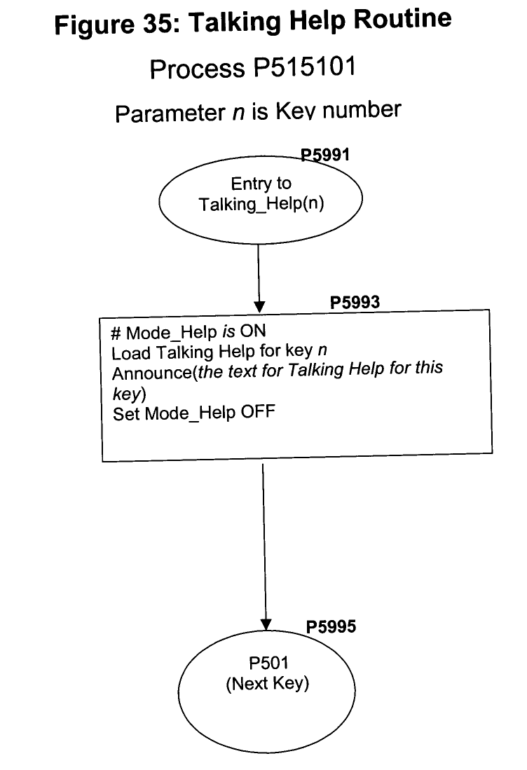

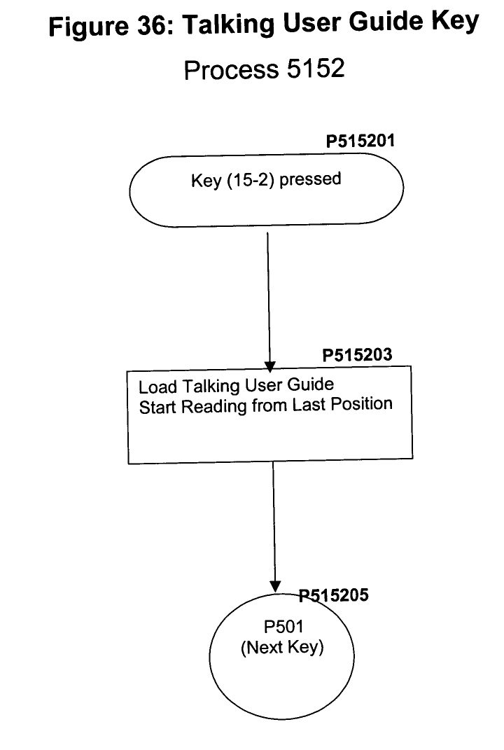

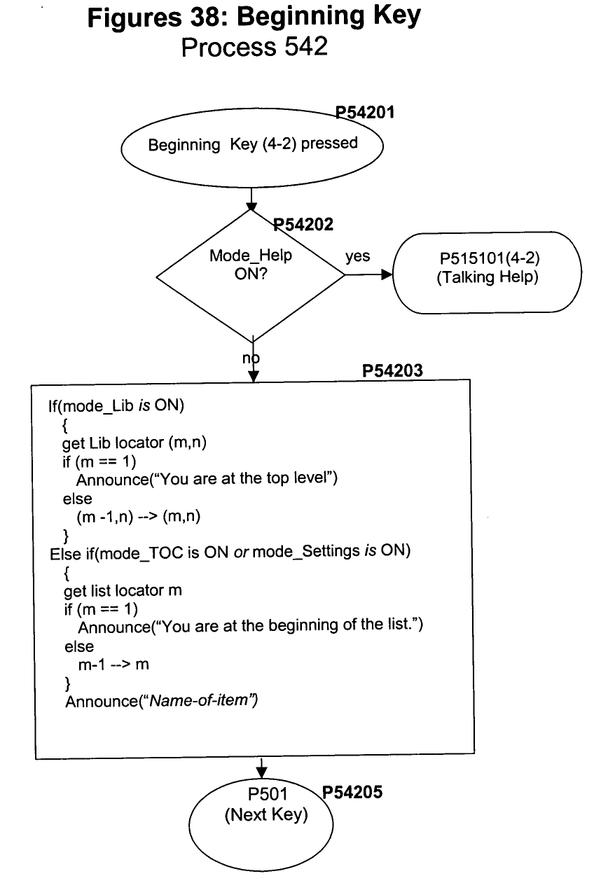

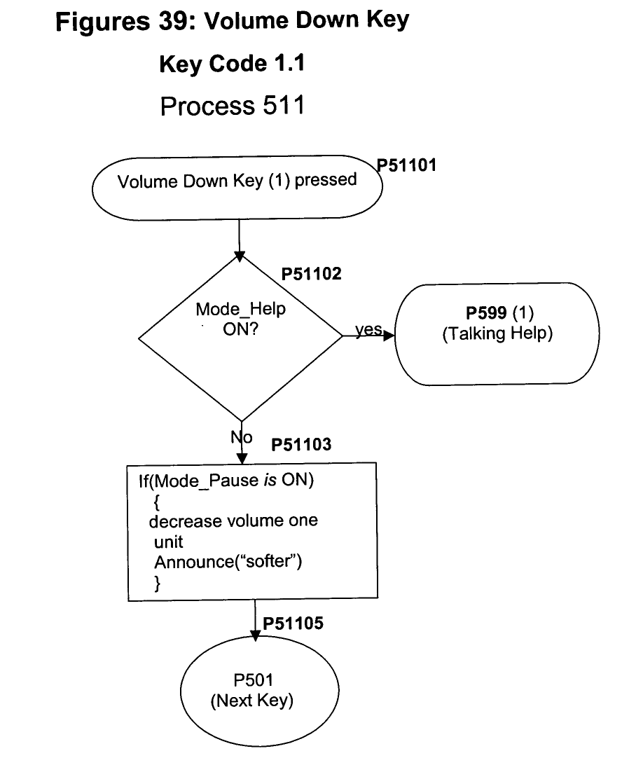

Talking Help may be accessed by pressing key (15), as shown in FIG. 24. The User may then press any other key to hear Talking Help for that key (refer to FIG. 35). All keys return to their normal function once the device begins reading the Talking Help. A Talking User Guide (FIG. 36) may also be provided. The User may also move to the beginning of a document (FIG. 38) and/or adjust the volume up and down, as illustrated in FIG. 39.

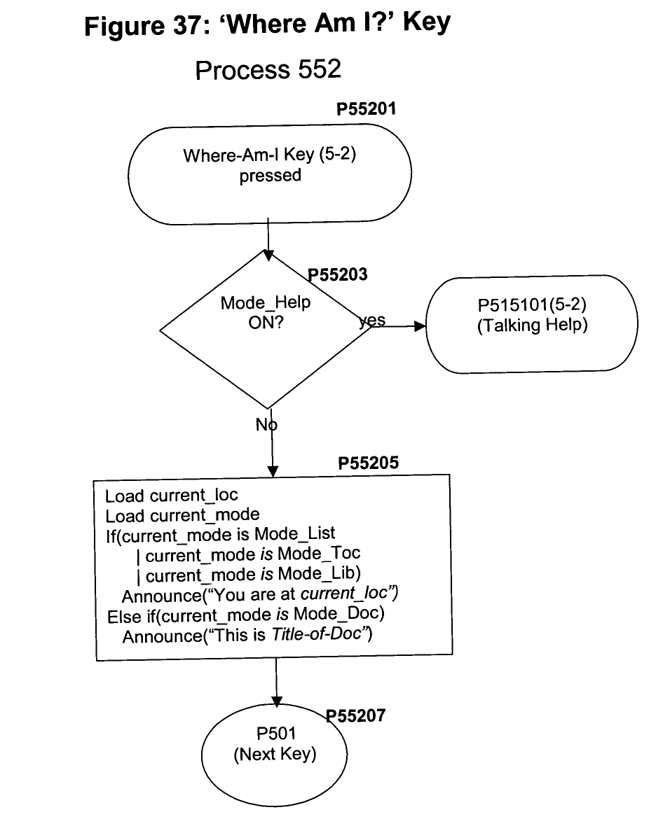

“Where Am I? ” (7-2), as illustrated in FIG. 37, causes the Client 12 to announce the name of the current document or list or position within the Virtual Library.

Environmental settings may be accessed by pressing the Settings List (13) key. The list of such settings may include Volume Control, Speed, Voice Type, Date/Time, Lock/Unlock File and many other system options. When any of these are accessed, the device may announce “settings list” and the first option on that list. The User navigates the master list in the usual manner (2 and 8 keys) and selects (5) the desired option when it is announced. Whenever the User selects an action, the Client 12 may confirm it with an announcement (FIG. 27, P55113).

For example, when the User selects the Speed option, the Client 12 may announce “Speed.” When the User adjusts the speed (2 and 8) the Client 12 may announce “slower/slowest” and “faster/fastest”. The User selects the preferred speed and the Client 12 may announce “You have changed the speed from (earlier value) to (new value).”

The Client 12 automatically employs Time Scale Modification (TSM) when changing the speed for both TTS and MP3 files. TSM allows the speed of the voice or other audio to be varied without varying the frequency or pitch. This preserves the clarity and naturalness of the sound even at very slow or very fast rates.

The other settings may be implemented in a similar manner, with the Client 12 guiding and confirming the User's actions with spoken feedback.

A plurality of other functions may be provided to the User, including but not limited to the ability to jump to the top or bottom of a file hierarchy, to speak one word at a time, to fast forward or fast reverse through a document, and to customize the operation of the Client 12 in a variety of ways (an “expert” mode). All of these options are possible within the existing art, without hardware modifications.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

What is claimed is:

1. A portable electronic device, comprising:
a user interface adapted to be operated by a print-disabled individual;
a memory that contains a database of content;
a text-to-speech converter; and
an audio output.

2. The device of claim 1 wherein the content comprises compressed audio format content files and compressed text format content files.

3. The device of claim 2 wherein the device is configured to decompress the text format content files and the text-to-speech converter is configured to deliver the decompressed text format content files in audio format in response to a user input.

4. The device of claim 2 wherein the text format content files have been pre-processed to filter material that is not necessary for text-to-speech conversion.

5. The device of claim 2 wherein each audio format content file and each text format content file is associated with at least one index file that is stored in the memory.

6. The device of claim 5 wherein, when a user selects an audio content format file, the text-to-speech converter is programmed to convert selected non-audio format information associated with the audio content format file into an audio format and present the converted selected information to the user as text-to-speech.

7. The device of claim 2, further comprising a decompression module that decompresses a user-selected compressed audio format content file or text format content file in real time during presentation of the file in audio format to a user.

8. The device of claim 1, further comprising a communication means that receives content updates from a remote computing device.

9. The device of claim 1, further comprising a processor programmed with time scale modification functions that adjust a delivery speed of the content when the content is presented to a user through the audio output.

10. The device of claim 1, further comprising a decryption module that, when a user selects a content file that is encrypted, decrypts the selected content file.

11. The device of claim 1 wherein the print-disabled individual is at least one of blind, visually impaired, dyslexic, or of less than complete literacy.

12. A content delivery system, comprising:
a server that includes a server content database and a server subscriber database; and
one or more portable electronic devices, each portable electronic device in communication with the server,
wherein each portable electronic device includes:
a user interface adapted to be operated by a print-disabled individual,
a memory that contains a device content database,
a text-to-speech converter, and
an audio output.

13. The system of claim 12 wherein each portable electronic device is programmed to periodically communicate with the server, receive an update from the server content database, and update the device content database with the update from the server content database.

14. The system of claim 12 wherein the content database of the portable device comprises compressed audio format content files and text format content files.

15. The system of claim 14, further comprising an audio file generator in communication with the server, wherein the audio file generator pre-processes the compressed audio format content files.

16. The system of claim 12, further comprising at least one communications link between the server and a plurality of remote content providers, wherein at least a portion of the content in the server content database has been received from the plurality of remote content providers via the at least one communications link.

17. The system of claim 12 wherein each portable electronic device further comprises a processor programmed with time scale modification functions that adjust a delivery speed of content from the content information database when said content is presented to a user through the audio output.

18. A method of delivering content to a print-disabled or visually-impaired individual, comprising:
providing an individual with a portable electronic device, wherein the device includes a user interface, a memory that contains text format content files and audio format content files, a text-to-speech converter for converting the text format content files to audio format, a processor programmed with time scale modification functions, and an audio output; and
periodically updating the memory with updated text format content files and updated audio format content files.

19. The method of claim 18, further comprising pre-processing the audio format content files.

20. The method of claim 18 wherein at least one of the updated text format content files has been received from a remote content provider.

21. The method of claim 18, further comprising providing the electronic device with at least one index file for each text format content file and audio format content file.

22. The method of claim 18 wherein the step of periodically updating is performed from a remote server via a communications link.

23. The method of claim 18 wherein the step of periodically updating is performed by providing the user with a replacement memory that contains the updated text format content files and audio format content files.

24. The method of claim 18, further comprising, in response to a request from a user to receive a content file, verifying that the user is authorized to receive the requested content file.

25. A user interface for a portable electronic device, comprising:
at least one volume control;
a document library control;
a table of contents control for selecting a table of contents in the document library;
a document selection control; and
a plurality of navigation controls for navigating through the document library and through individual documents selected from the library.

26. The user interface of claim 25, further comprising at least one bookmark control.

27. The user interface of claim 25 wherein the plurality of navigation controls include a forward control and a back control.

28. The user interface of claim 25 wherein the plurality of navigation controls include a document start control and a document end control.

29. A database structure, comprising:
a plurality of content files, wherein the content files include text format files and audio format files; and
a plurality of index files, wherein at least one index file is associated with one of the content files, and wherein the at least one index file includes data corresponding to a plurality of locations within the associated content file.

30. The database structure of claim 29 wherein each of the content files is associated with at least one library, and wherein each library includes a table of contents.

31. The database structure of claim 29 wherein each index file further includes data corresponding to a title of the associated content file.

32. The database structure of claim 29, further comprising at least one catalog file, wherein the catalog file includes data corresponding to a plurality of available content files.
